(19) United States
(12) Patent Application Publication
(10) Pub. No.: US 2019/0114401 A1
(43) Pub. Date: Apr. 18, 2019

(54) ON DEVICE STRUCTURE LAYOUT RANDOMIZATION FOR BINARY CODE TO ENHANCE SECURITY THROUGH INCREASED ENTROPY

(71) Applicant: QUALCOMM Incorporated, San Diego, CA (US)

(72) Inventors: Subrato Kumar DE, San Diego, CA (US); Zine-el-abidine BENAISSA, San Diego, CA (US)

(21) Appl. No.: 16/119,294

(22) Filed: Aug. 31, 2018

Related U.S. Application Data
(60) Provisional application No. 62/571,723, filed on Oct. 12, 2017.

(51) Int. Cl. G06F 21/12; G06F 21/64; G06F 21/51; H04L 9/32

(52) U.S. Cl. CPC G06F 21/125; G06F 21/64; G06F 8/41; H04L 9/3247; G06F 21/51

(57) ABSTRACT

Techniques for securing executable code on a computing device are provided. An example method according to the disclosure includes accessing an image file comprising intermediate code or binary object code; accessing metadata associated with the image file, the metadata providing layout information for a layout of one or more randomizable components in the image file, where the one or more randomizable components comprise variables of one or more structure types, objects of one or more class types, one or more data sections in the image file, function argument list, or a combination of two or more of these; and randomizing the layout of elements of instances of the one or more randomizable components using the metadata to generate randomized intermediate code executable by a virtual machine or randomized binary object code executable by the computing device.

### CLAIM OF PRIORITY UNDER 35 U.S.C. § 119

The present Application claims the benefit of and priority to U.S. Provisional Application Ser. No. 62/571,723, entitled “ON DEVICE STRUCTURE LAYOUT RANDOMIZATION FOR BINARY CODE TO ENHANCE SECURITY THROUGH INCREASED ENTROPY,” filed Oct. 12, 2017, which is assigned to the assignee hereof, and expressly incorporated herein by reference.

### BACKGROUND

Cyber attackers often corrupt data structures within executing Binary Object Code to compromise software systems. These attacks require determining the layout of a structure or aggregate containing sensitive data/information. As a preventative measure, randomization of the layouts of structures or aggregates has been proposed in research and industry, where the layout of the structures and the relative positioning of the various fields/members/elements within it are randomly placed instead of the default layout as defined in the program's source code.

A couple of conventional techniques to randomization are discussed below, but each of these techniques has significant drawbacks that can significantly impact security, performance, or both. One technique is to perform layout randomization of structures or aggregates during compilation time. The most common approach is to use a random seed during compilation, and based on that random seed, randomize the layout of the structures or aggregates. This approach results in different compiled images from the same sources having different randomized structures. However, when a large binary distribution is made (e.g., Applications in App Store, Kernel Images, binary libraries, etc.) the compile time structure randomization is not secure, because all binary installations from the same binary originate from the same compilation instance. As a result, all of the binary installations from the same compilation instance will have the same snapshot of the randomized instance, because all of the binary installations utilized the same random seed value during compilation. This technique does not add performance overhead. But, the security of benefits of this technique are limited because the randomization provided is limited. The binary code produced using this technique can be subject to wide-spread threats that can attack the same vulnerability across multiple devices and/or computing platforms that have the same version of the binary distribution installed.

Another technique for randomization adds framework/manager code during compilation that is included in the binary image distribution and facilitates randomization of structure layout during execution. However, this approach adds a high-performance overhead (e.g., 16% for Linux kernel code, 5-8% for applications, etc.) due to the infrastructure code that helps in managing randomization and keeping track of the current randomized layout during execution. Code similar to runtime management code is included with the application binary to trigger and to keep track of the randomization by inserting specific software operations before and after the structure access instructions. These changes to the code are done during compilation time but are activated during execution facilitating randomization of the structures or aggregates. This technique can provide extremely high levels of randomization, thereby increasing the security of the binary code. Compromises in the runtime infrastructure code may be exploited by an attacker. But, each device would have a unique randomization that would require an attacker to focus on a single-device exploit that would work only for a specific device. However, this approach results in high runtime performance penalties that can get even worse on a mobile device, and hence unsuitable commercially.

### SUMMARY

An example method for securing executable code according to the disclosure includes accessing an image file comprising intermediate code or binary object code; accessing metadata associated with the image file, the metadata providing layout information for a layout of one or more randomizable components in the image file, where the one or more randomizable components comprise variables of one or more structure types, objects of one or more class types, one or more data sections in the image file, function argument list, or a combination of two or more of these; and randomizing the layout of elements of instances of the one or more randomizable components using the metadata to generate randomized intermediate code executable by a virtual machine or randomized binary object code executable by the computing device.

Implementations of such a method can include one or more of the following features. Randomizing the layout of the elements of instances of the one or more randomizable components can include determining, for a respective one of the one or more randomizable components, a randomized layout by determining new memory offsets within the respective one of the one or more randomizable components for each element of the respective one of the one or more randomizable components based on the layout information included in the metadata associated with the respective one of the one or more randomizable components, and rewriting the binary object code or the intermediate code to update instruction accesses to include the randomized layout for each instance of the respective one of the one or more randomizable components. Determining, for the respective one of the one or more randomizable components, the randomized layout include padding the randomized layout to satisfy one or more alignment requirements associated with the elements of the respective one of the one or more randomizable components. Determining, for the respective one of the one or more randomizable components, the randomized layout includes spreading the elements of the respective one of the one or more randomizable components throughout memory allocated to the respective one of the one or more randomizable components to increase entropy associated with the randomized layout of the respective one of the one or more randomizable components. Determining, for the respective one of the one or more randomizable components, the randomized layout includes randomizing an order of register-based function parameters for each function of the respective one of the one or more randomizable components; and randomizing an order of stack-based function parameters for the respective one of the one or more randomizable components. Determining, for the respective one of the one or more randomizable components, the randomized layout includes determining a separate randomized layout for each level of inheritance and for virtual function tables associated with the respective one of the one or more randomizable components. The maximum size for each of the one or more randomizable components is determined based on alignment constraints, padding constraints, and program-specified attributes and constraints for the respective one of the one or more randomizable components and the elements of the respective one of the one or more randomizable components. The layout information of the metadata comprises position or offset information, size information, and a data type information for each member of the respective one of the one or more randomizable components. The metadata includes address offset information of each instruction included in the intermediate code or the binary object code that accesses or sets a size of one of the one or more randomizable components, and base register offset information associated with each element being accessed or set by each instruction. Rewriting debug symbol offsets and sizes of debugging information according to the randomized layout of the elements of instances of the one or more randomizable components. Reconverting the randomized intermediate code or the randomized binary object code to original intermediate code or binary code using the metadata to restore an original layout for the one or more randomizable components in the image file for the one or more randomizable components. Restoring at least one of a function argument ordering and debug symbol offsets associated with each of the one or more randomizable components to original values. Signing reconverted intermediate code or reconverted binary object code using a device-specific cryptographic key associated with the computing device after reconverting the randomized intermediate code or the randomized binary object code to the original intermediate code or binary code using the metadata to restore the original layout, when either integrity protection is needed, or the image file was signed, and integrity protected. Signing the randomized intermediate code or the randomized binary object code using a device-specific cryptographic key associated with the computing device when either integrity protection is needed, or the image file was signed, and integrity protected. Randomizing the layout of the elements of instances of the one or more randomizable components using the metadata to generate the randomized intermediate code or the randomized binary object code is performed responsive to an application utilizing the intermediate code or the binary object code being executed on the computing device, and the method also includes loading the randomized intermediate code or the randomized binary object code into a memory of the computing device from which the randomized intermediate code or the randomized binary object code can be executed. Storing the intermediate code or the binary object code from the image file in an original form a persistent memory of the computing device. Replacing the intermediate code or the binary object code in the original form with the randomized intermediate code or the randomized binary object code. Signing the randomized intermediate code or the randomized binary object code using a device-specific cryptographic key. Storing the randomized intermediate code or the randomized binary object code in the persistent memory of the computing device with the intermediate code or the binary object code in the original form. Rewriting one or more of function parameter order information and virtual function tables according to the randomized layout of the elements of instances of the one or more randomizable components. The one or more randomizable components comprise an object, where randomizing the layout of the elements of instances of the one or more randomizable components also rewriting one or more of address offset information, base register offset information, function parameter order information, a virtual function table, debug information such that the layout of the elements of the object at each level of inheritance are independently randomized.

An example computing device according to the disclosure includes means for accessing an image file comprising intermediate code or binary object code; means for accessing metadata associated with the image file, the metadata providing layout information for a layout of one or more randomizable components in the image file, where the one or more randomizable components comprise variables of one or more structure types, objects of one or more class types, one or more data sections in the image file, function argument list, or a combination of two or more of these; and means for randomizing the layout of elements of instances of the one or more randomizable components using the metadata to generate randomized intermediate code executable by a virtual machine or randomized binary object code executable by the computing device.

Implementations of such a computing device can include one or more of the following features. The means for randomizing the layout of the elements of instances of the one or more randomizable components includes means for determining, for a respective one of the one or more randomizable components, a randomized layout by determining new memory offsets within the respective one of the one or more randomizable components for each of the elements of the respective one of the one or more randomizable components based on the layout information included in the metadata associated with the respective one of the one or more randomizable components; and means for rewriting the binary object code or the intermediate code to update instruction accesses to include the randomized layout for each instance of the respective one of the one or more randomizable components. The means for determining, for the respective one of the one or more randomizable components, the randomized layout includes means for padding the randomized layout to satisfy one or more alignment requirements associated with the elements of the respective one of the one or more randomizable components.

An example computing device according to the disclosure includes a processor configured to access an image file comprising intermediate code or binary object code; access metadata associated with the image file, the metadata providing layout information for a layout of one or more randomizable components in the image file, where the one or more randomizable components comprise variables of one or more structure types, objects of one or more class types, one or more data sections in the image file, function argument list, or a combination of two or more of these; and randomize the layout of elements of instances of the one or more randomizable components using the metadata to generate randomized intermediate code executable by a virtual machine or randomized binary object code executable by the computing device. The processor being configured to randomize the layout of the elements of instances of the one or more randomizable components is further configured to determine, for a respective one of the one or more randomizable components, a randomized layout by determining new memory offsets within the respective one of the one or more randomizable components for each element of the respective one of the one or more randomizable components based on the layout information included in the metadata associated with the respective one of the one or more randomizable components; and rewrite the binary object code or the intermediate code to update instruction accesses to include the randomized layout for each instance of the respective one of the one or more randomizable components. The processor being configured to determine the randomized layout is further configured to pad the randomized layout to satisfy one or more alignment requirements associated with the elements of the respective one of the one or more randomizable components.

An example non-transitory, computer-readable medium according to the disclosure, has stored thereon computer-readable instructions for securing program code on a computing device. The instructions are configured to cause the computing device to access an image file comprising intermediate code or binary object code; access metadata associated with the image file, the metadata providing layout information for a layout of one or more randomizable components in the image file, where the one or more randomizable components comprise variables of one or more structure types, objects of one or more class types, one or more data sections in the image file, function argument list, or a combination of two or more of these; and randomize the layout of elements of instances of the one or more randomizable components using the metadata to generate randomized intermediate code executable by a virtual machine or randomized binary object code executable by the computing device. The instructions configured to cause the computing device to randomize the layout of the elements of instances of the one or more randomizable components further comprise instructions configured to cause the computing device to determine, for a respective one of the one or more randomizable components, a randomized layout by determining new memory offsets within the respective one of the one or more randomizable components for each element of the respective one of the one or more randomizable components based on the layout information included in the metadata associated with the respective one of the one or more randomizable components; and rewrite the binary object code or the intermediate code to update instruction accesses to include the randomized layout for each instance of the respective one of the one or more randomizable components. The instructions configured to cause the computing device to determine the randomized layout further comprise instructions configured to cause the computing device to pad the randomized layout to satisfy one or more alignment requirements associated with the elements of the respective one of the one or more randomizable components.

### BRIEF DESCRIPTION OF THE DRAWING

FIG. 1 is a diagram of an example operating environment in which the techniques disclosed here can be implemented according to the disclosure.

FIG. 2 is a block diagram of an example computing device that can be used to implement the source device illustrated in the preceding example.

FIG. 3 is a block diagram of an example computing device that can be used to implement the client device illustrated in the preceding examples.

FIGS. 4A and 4B illustrate an example of randomization that can be implemented according to the techniques disclosed herein.

FIGS. 5A and 5B illustrate example metadata that illustrates the techniques disclosed herein.

FIG. 6 illustrates example data structures for a 32-bit machine for a 64-bit machine that illustrates the techniques disclosed herein.

FIG. 7 is a high level schematic diagram illustrating the functional components of an example of a compiler that can be used to implement the techniques disclosed herein.

FIG. 8 is a schematic diagram illustrating an example implementation of a computing device that can be used to implement the techniques disclosed herein.

FIG. 9 is a flow diagram of an example process for example process for generating executable code on a computing device according to the disclosure.

FIG. 10 is a flow diagram of an example process for example process for identifying the randomizable components and generating the metadata according to the disclosure.

FIG. 11 is a flow diagram of an example process for example process for generating executable code on a computing device according to the disclosure.

FIG. 12 is a flow diagram of an example process for example process for generating executable code on a computing device according to the disclosure.

FIG. 13 is a flow diagram of an example process for example process for generating executable code on a computing device according to the disclosure.

FIG. 14 is a flow diagram of an example process securing executable code on a computing device according to the disclosure.

FIG. 15 is a flow diagram of an example process securing executable code on a computing device according to the disclosure.

FIG. 16 is a flow diagram of an example process securing executable code on a computing device according to the disclosure.

FIG. 17 is a flow diagram of an example process securing executable code on a computing device according to the disclosure.

FIG. 18 is a flow diagram of an example process securing executable code on a computing device according to the disclosure.

FIG. 19 is a flow diagram of an example process securing executable code on a computing device according to the disclosure.

FIG. 20 is a diagram illustrating an example of ASLR-based randomization compared to an example of metadata-driven randomization according to the techniques disclosed herein.

FIG. 21 is a diagram illustrating an example of randomization of a C++class according to the disclosure.

FIG. 22 is a diagram illustrating an example of function parameter randomization according to the disclosure.

FIG. 23 is a diagram illustrating an example of randomization of debug information according to the disclosure.

FIG. 24 is a flow diagram of an example process for randomizing the layout of debugging information according to the disclosure.

FIG. 25 is a flow diagram of an example process for restoring an original layout of randomized debugging information according to the disclosure.

Like reference symbols in the various drawings indicate like elements, in accordance with certain example implementations.

### DETAILED DESCRIPTION

Techniques for randomization of the layout of randomizable components of binary object code and/or intermediate code that address the shortcomings of the conventional randomization solutions for structures, objects, and/or other aggregate data structures are provided. The one or more randomizable components can include one or more data structures, one or more objects, one or more data sections in the image file, or a combination of two or more of these randomizable components. The techniques disclosed herein provide increased entropy over solutions where the randomization is fixed at compile time without introducing the high performance overhead introduced by solutions that facilitate randomization at execution time. The techniques disclosed herein can provide a two-part solution for randomization of the layout of structures in the binary code. The first part of the solution occurs at the time that the program code is compiled at a source computing device. The compiler can be configured to generate metadata that includes layout information for one or more randomizable components of the program code. The compiler can be configured to generate an image file comprising binary object code and/or intermediate code depending on the implementation and the configuration of the client device on which the image file is to be deployed. The metadata can be included in the image file or can alternatively be provided as a separate file to the client device.

The compiler of the source device does not perform the randomization of the binary object code and/or intermediate code output by the compiler. Instead, randomization of the binary object code and/or intermediate code is handled in the second part of the solution implemented on the client computing device on which the binary object code and/or intermediate code is to be deployed. The client computing device can implement a randomization unit. The randomization unit is configured to access the metadata associated with the image file and to identify the randomizable components included in the binary object code and/or intermediate code included in the image file. The randomization unit can be configured to utilize the metadata information to randomize the layout of the randomizable components that are identified in the metadata generated by the source device. The randomization unit can be configured to update the instructions of the binary object code and/or the intermediate code associated with writing values to and reading values from the randomizable components whose layouts are randomized. The randomization unit can also be configured to randomize each level of inheritance of objects and each level of inheritance can be separately randomized. The randomization unit can also be configured to update the order of parameters included in function or method calls made within the binary object code and/or the intermediate code. The randomization unit can be configured to group the parameters into stack-based parameters and register-based parameters and to reorder to randomize the order of the parameters for each group of parameters. The randomization unit can also be configured to update debug offsets for the randomized binary object code and/or the intermediate code to facilitate debugging of the code even after the code has been randomized. The randomization unit can also be configured to determine whether there are any constraints on the randomization of the randomizable components based on the information included in the metadata. These techniques will be illustrated in greater detail in the discussion of the examples that follow.

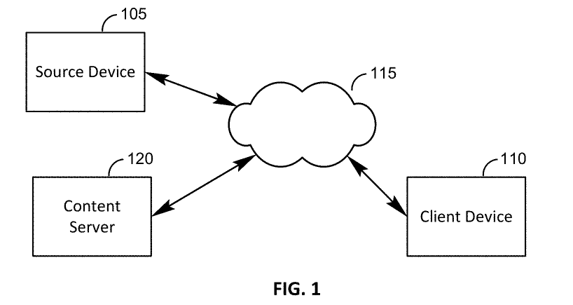

FIG. 1 is an example operating environment in which the techniques disclosed herein can be implemented. The example operating environment includes a source device 105, a client device 110, a network 115, and a content provider 120.

The source device 105 can be associated with an application developer or a distributor of software. The source device 105 is computing device that is configured to generate executable program code by compiling source code. The executable program code can comprise binary object code and/or intermediate code. The executable program code and/or intermediate code can be associated with an application that can be executed on the client device 110.

Binary object code typically comprises relocatable format machine code that may not be directly executable by the client device 110 until the binary object code is linked to form an executable file or a library file. The binary object code can comprise machine language or can comprise an intermediate language such as register transfer language (RTL). Binary object code can be distributed in various formats, such as but not limited to the Common Object File Format (COFF) and the Executable and Linkable Format (ELF).

The intermediate code can comprise bytecode. Bytecode can also be referred to as portable code, because bytecode is typically platform independent unlike binary object code. The intermediate code is typically executed by an interpreter (or a runtime environment with an ahead-of-time compiler, or a just-in-time compiler) being executed on the client device 110. The interpreter can directly execute the bytecode without the bytecode being compiled into machine code. In some implementations, the bytecode can be compiled into binary object code by a compiler on the client device 110.

The source device 105 can be configured to identify one or more randomizable components in the source code for which the layout of the elements of the one or more randomizable component is to be randomized. The one or more randomizable components can include one or more data structures, one or more objects, one or more data sections in the image file, or a combination of two or more of these. The elements of the data section can include content, such as but not limited to read-only data segments (.rodata), statically allocated variables (.bss), constant variables (.const). The one or more randomizable components can include data structures, objects, or both depending on the whether the program code is based on a procedural programming language or an object-oriented programming language. The term “element” as used herein can refer to the members, fields, and/or elements of a structure, an object, or other type of aggregate data structure that forms a logical grouping of one or more data elements. The randomizable component can also include an interface for setting a value of an element(s) of the randomizable component, getting a value of the element(s) of the randomizable component, and/or for performing other operations on a value of an element of the randomizable component. This interface can include one or more methods, functions, or other procedures for acting upon the element(s) of the randomizable component. Each element may be a primitive data type, such as but not limited an integer, floating point number, character, or string, or may be another type of data structure or object, which in turn may include one or more elements. The elements are typically allocated at known memory locations within an instance of a structure, an object, or other type of aggregate data structure. However, the techniques disclosed herein can randomize the layout of the elements within a structure, an object, or other type of aggregate data structure to make an attack on the binary object code or intermediate code in which the structure, an object, or other type of aggregate data structure is utilized much more difficult.

The one or more randomizable components in the source code can be identified by the compiler or can be flagged by a programmer in the program code that is to be compiled. The source device 105 can include a metadata generation unit that is configured to generate metadata that includes layout information for the one or more randomizable components for which the layout of the elements of the data can be randomized at the client device 110. The metadata generation unit can be implemented as a module of the compile of the source device 105 or can be implemented as separate component of the source device 105.

The compiler of the source device 105 can generate an image file that includes the binary object code and/or the intermediate code. The metadata may be inserted into the image file or may be distributed as a separate file that is provided to the client device 110 and/or the content provider 120 with the image file. In some implementations, the metadata generation unit or the compiler of the source device 105 can be configured to insert the metadata into the image file that is generated at the source device 105. In other implementations, the source device 105 can be configured to provide the image file and the metadata as separate files to the client device 110 and/or the content provider 120 via the network 115. Furthermore, the source device 105 and/or the content provider 120 can be configured to provide a user interface that enables a user of the client device 110 to download software content from the source device 105 and/or the content provider 120. The client device 110 can also be configured to periodically check with the source device 105 and/or the content provider 120 for updates to software on the client device 110 and to download one or more image files from the source device 105 responsive to software updates being available. The source device 105 can also be configured to push the image file out to the client device 110 as a software update. The source device 105 can provide the metadata generated for the image file to client device 110 and/or the content provider 120.

The content provider 120 can be an application store or other type of repository for software that is downloadable to the client device 110. The software downloads provided by the content provider 120 may be purchased by a user of the client device 110 or may be free to download, depending on the content to be downloaded. The content provider 120 can also be configured to push software updates to the client device 110 including but not limited to application updates, driver updates, operating system updates, and/or other software content that may be utilized by the content provider 120. The content provider 120 can provide the metadata generated for the image file by the source device 105 to client device 110. The metadata may be inserted into the image file or may be distributed as a separate file that is provided to the client device 110 with the image file.

The image file can be configured to perform various functions on the on the client device 110. For example, the image file can comprise executable program code for a bootloader, updates for the operating system of the client device 110, or other application to be executed by the computing device. The image file can include program code for one or more libraries that can be used by one or more applications on the client device 110. The image file can also include content related to one or more new applications to be installed on and/or executed by the client device 110. The purpose of the content included in a particular image file is not important for the purposes of the techniques disclosed herein, and the types of content that may be included in an image file may differ from the preceding examples.

The client device 110 can be a mobile computing device, such as a smartphone, a tablet computer system, a laptop computer system, or a wearable computing device (including but not limited to a smartwatch). The client device 110 can be a computing device that is substantially stationary, which may be movable but is typically not moved regularly, such as a desktop computing system, a game console, a set top box, a computer server, or other such computing device that is typically not moved. The form factor of the client device 110 is not important for the techniques disclosed herein. The preceding examples are merely intended to illustrate some of the types of computing devices that could be the client device 110, but are not intended to limit the techniques disclosed herein to a specific type of client device 110.

The client device 110 is configured to accessing the image file generated by the source device 105 to access the intermediate code executable by a virtual machine on the computing device or binary object code executable by the client device 110 included therein. The client device 110 can also access the metadata associated with the image file, including extracting the metadata from the image file in implementations where the metadata has been inserted into the image file. As discussed above, the metadata provides layout information for a layout of one or more randomizable components in the image file that was generated by the source device 105 at the time that image file was created. The one or more randomizable components can include one or more data structures, one or more objects, one or more data sections in the image file, or a combination of two or more of these items. The client device 110 can be configured to randomize the layout of the elements of instances of the one or more randomizable components in the intermediate code and/or binary object code using the layout information obtained from the metadata to generate randomized intermediate code executable by the virtual machine or randomized binary object code that is executable by the client device 110. The randomization process alters the layout of the elements of the data structures and/or objects included in the binary object code or intermediate code. The randomization process is performed on the client device 110 and results in a uniquely randomized version of the binary object code or intermediate code, in contrast with some conventional techniques in which a single randomized binary or a limited number of randomized binaries are generated. The randomization process also updates the debug information associated with the binary object code or intermediate code so that the debug offsets match those of the randomized binary object code or randomized intermediate code, which facilitates debugging of the randomized code. Furthermore, the client device 110 can also be configured to digitally sign the randomized image file. The example implementations that follow will discuss these aspects in greater detail.

The examples that follow provide additional details regarding the source device 105 and the client device 110. The example operating environment illustrated in FIG. 1 is an example of one possible operating environment in which the techniques disclosed herein may be implemented. One or more of the elements discussed in the example illustrated in FIG. 1 may be combined. For example, the source device 105 and the content provider 120 may be combined in some implementations. Furthermore, the content provider 120 may be omitted in other implementations. Furthermore, in some implementations, the binary image file may be stored on a persistent, computer-readable memory device and the memory device on which the image file is stored may be provided to the client device 110.

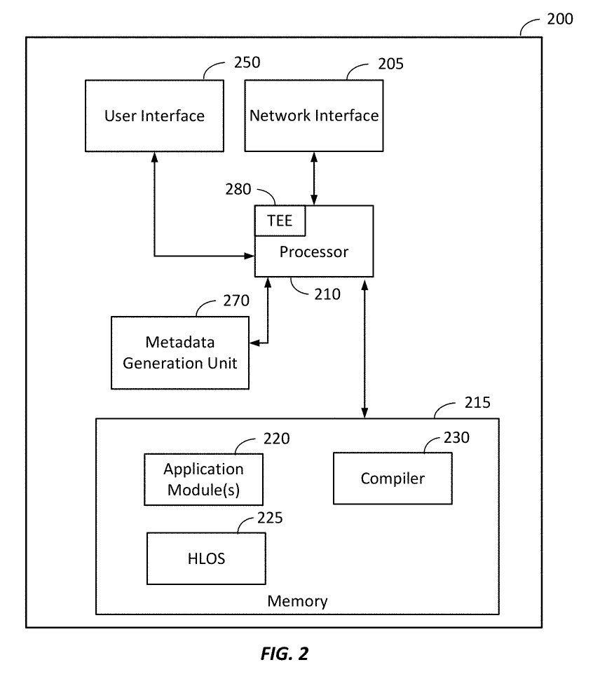

FIG. 2 is a functional block diagram of an example computing device 200 that can be used to implement the source device 105 discussed in the preceding example implementation. For the sake of simplicity, the various features/components/functions illustrated in the schematic boxes of FIG. 2 can be connected using a common bus or are can be otherwise operatively coupled together. Other connections, mechanisms, features, functions, or the like, may be provided and adapted as necessary to operatively couple and configure a computing device 200. Furthermore, one or more of the features or functions illustrated in the example of FIG. 2 may be further subdivided, or two or more of the features or functions illustrated in FIG. 2 may be combined. Additionally, one or more of the features or functions illustrated in FIG. 2 may be excluded.

As shown, the computing device 200 can include a network interface 205 that can be configured to provide wired and/or wireless network connectivity to the computing device 200. The network interface can include one or more local area network transmitters, receivers, and/or transceivers that can be connected to one or more antennas (not shown). The one or more local area network transmitters, receivers, and/or transceivers comprise suitable devices, circuits, hardware, and/or software for communicating with and/or detecting signals to/from one or more of the wireless local area network (WLAN) access points, and/or directly with other wireless computing devices within a network. The network interface 205 can also include, in some implementations, one or more wide area network transmitters, receivers, and/or transceivers that can be connected to the one or more antennas (not shown). The wide area network transmitters, receivers, and/or transceivers can comprise suitable devices, circuits, hardware, and/or software for communicating with and/or detecting signals from one or more of, for example, the wireless wide area network (WWAN) access points and/or directly with other wireless computing devices within a network. The network interface 205 can include a wired network interface in addition to one or more of the wireless network interfaces discussed above. The network interface 205 can be used to receive data from and send data to one or more other network-enabled devices via one or more intervening networks.

The processor(s) 210 may be connected to the memory 215, the metadata generation unit 270, the user interface 250, and the network interface 205. The processor may include one or more microprocessors, microcontrollers, and/or digital signal processors that provide processing functions, as well as other calculation and control functionality. The processor 210 may be coupled to storage media (e.g., memory) 215 for storing data and software instructions for executing programmed functionality within the computing device. The memory 215 may be on-board the processor 210 (e.g., within the same integrated circuit package), and/or the memory may be external memory to the processor and functionally coupled over a data bus. The memory 215 can comprise volatile memory, persistent memory, or a combination thereof.

A number of software modules and data tables may reside in memory 215 and may be utilized by the processor 210 to manage, create, and/or remove content from the computing device 200 and/or perform device control functionality. Furthermore, components of the high-level operating system (“HLOS”) 225 of the computing device 200 may reside in the memory 215. A compiler 230 may also reside in the memory 215. As illustrated in FIG. 2, in some embodiments, the memory 215 may include an application module 220 which can implement one or more applications. It is to be noted that the functionality of the modules and/or data structures may be combined, separated, and/or be structured in different ways depending upon the implementation of the computing device 200. The application module 220 can comprise one or more trusted applications that can be executed by the trusted execution environment 280 of the computing device 200.

The application module 220 may be a process or thread running on the processor 210 of the computing device 200, which may request data from one or more other modules (not shown) of the computing device 200. Applications typically run within an upper layer of the software architectures and may be implemented in a rich execution environment of the computing device 200 (also referred to herein as a “user space”), and may include games, shopping applications, content streaming applications, web browsers, location aware service applications, etc. The application module 220 can be configured to comprise one or more applications that can be executed on the computing device 200.

The compiler 230 can be implemented as software stored in the memory 215 of the computing device 200. The compiler 230 can be a trusted application that is executed by the TEE 280. The compiler 230 can be configured to generate executable program code that can be included in an image file that can be provided to the client device 110 and/or the content provider 120. The executable program code can comprise binary object code and/or intermediate code. The binary object code can comprise machine language or can comprise an intermediate language such as register transfer language (RTL). The compiler can be configured to format the binary object code and/or the intermediate code in the image file using various formats, including but not limited to Common Object File Format (COFF) and the Executable and Linkable Format (ELF). The intermediate code generated by the compiler 230 can comprise bytecode which comprises program instructions that are intended to be executed by an interpreter of the client device 110 or may be compiled into machine code for execution before execution by the client device 110.

The compiler 230 used to generate the binary object code or intermediate code for the client device 110 can be configured to generate and associate metadata with one or more one or more randomizable components including one or more data structures, one or more objects, one or more data sections in the image file, or a combination of two or more of these items included in the binary object code or intermediate code generated by the compiler 230. The image file generated by the compiler can be in various object file formats, such as but not limited to Common Object File Format (COFF) or Executable and Linkable Format (ELF). The compiler 230 can be configured to allow an application programmer to add tags to source code and/or otherwise annotate the source code to identify randomizable components that comprise sensitive information and that should be randomized to provide increased security. The following is an example of a structure that includes a “Sensitive” identifier that can be used to indicate to the compiler 230 that the structure comprises sensitive information and should be randomized:

struct _{——}attribute_{——}((randomize)) Sensitive {
int (*getSocialSecurity)( );
int (*getBankNumber)( );
....
}

The preceding example illustrates one way in which a program code may be annotated and is not intended to limit the techniques disclosed herein to these specific examples. The compiler 230 can be configured to recognize other types of annotations that are included in the program code in addition to on instead of the preceding example. The compiler 230 can be configured to determine whether the user-provided annotations satisfy certain criteria and can be configured to emit an error in response to the user-provided annotations not satisfying one or more of these criteria. The compiler can be configured to ensure that the program code to be randomized meets various criteria including but not limited to: (1) type casting of randomized structures is not allowed; (2) mixed usage of randomized/non-randomized objects or structures—all instances of a particular object or structure included in the program code should be randomized; (3) forward declarations are not allowed—the structure or object must be defined in order for the compiler to be able to generate the metadata; (4); each level of inheritance for a class is independently randomized, so that different classes that inherit a particular class type that is randomized gets the same randomized layout of the particular class type, and interface objects, where classes whose objects are passed to public interfaces, are not randomized; (5) randomization of should not be applied to public elements of classes that are part of a public application programming interface (API); (6) structures should be used rather than unions because structures allocate memory to the structure's elements while the union allocates a common memory segment for all of the union's elements; (7) assumptions about the size of the randomized structure or object is not allowed—the sizeof function or equivalent thereto in the programming language being utilized should be used to allocate the memory required for the randomized structure or object; and (8) contents of structures or objects cannot be accessed by hard-coded constant values anywhere within the program code—the element/member/field names of the instances should be used in program code to facilitate randomization of the layout of the structure or object. The compiler 230 can be configured to emit an error in response to any of these criteria or other criteria that may be required by a particular implementation having not been met by the program code. The compiler 230 can be configured to halt the compilation process and to not produce the image file in response to the one or more of these criteria not being met. The compiler 230 can be configured to continue with the compilation and generate the image file even when some of these criteria are not met, however it would not generate any metadata for those objects, classes, structures, code components and potentially randomizable components for which the constraints are not met. This still allows for a binary to be generated for execution but limits the randomization components within the binary to only those portions that satisfied the constraints. The compiler 230 can generate the image file and metadata responsive to these criteria being met and no other errors occur that would preclude the compiler 230 from generating the image file. The compiler 230 can insert the metadata into the image file or can provide the image file and metadata separately to the client device 110 and/or the content provider 120.

The computing device 200 may further include a user interface 250 providing suitable interface systems for outputting audio and/or visual content, and for facilitating user interaction with the computing device 200. The computing device 200 may include additional user interface components, such as a keypad and/or a touchscreen for receiving user inputs, and a display (which may be separate from the touchscreen or be the touchscreen) for displaying visual content.

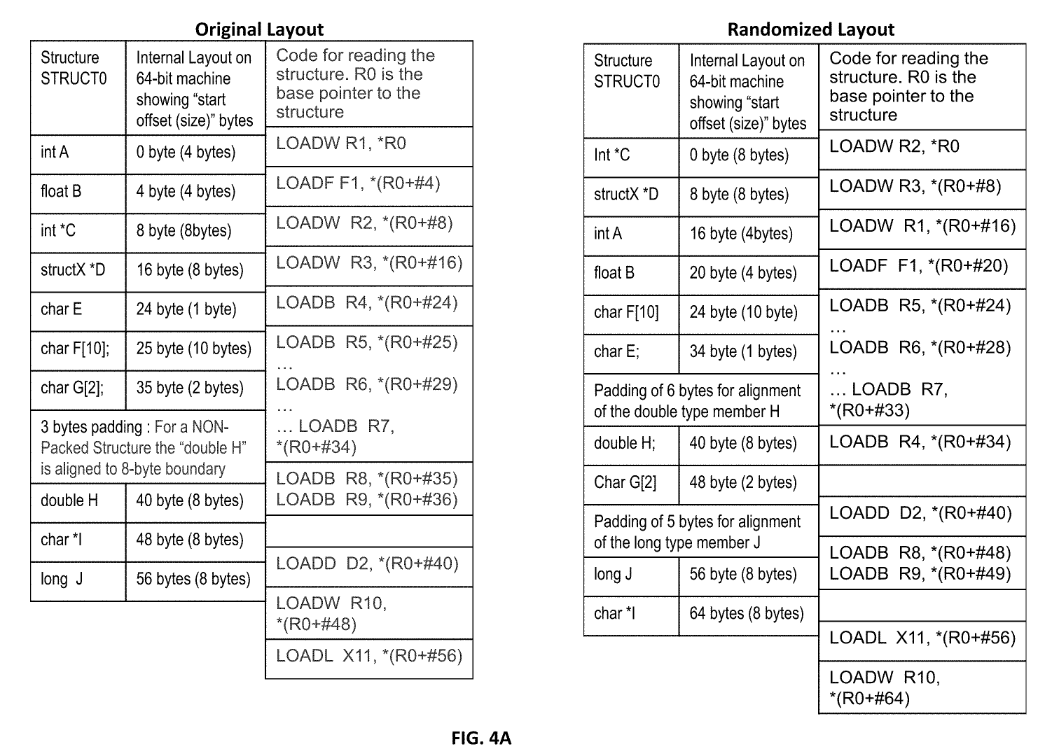

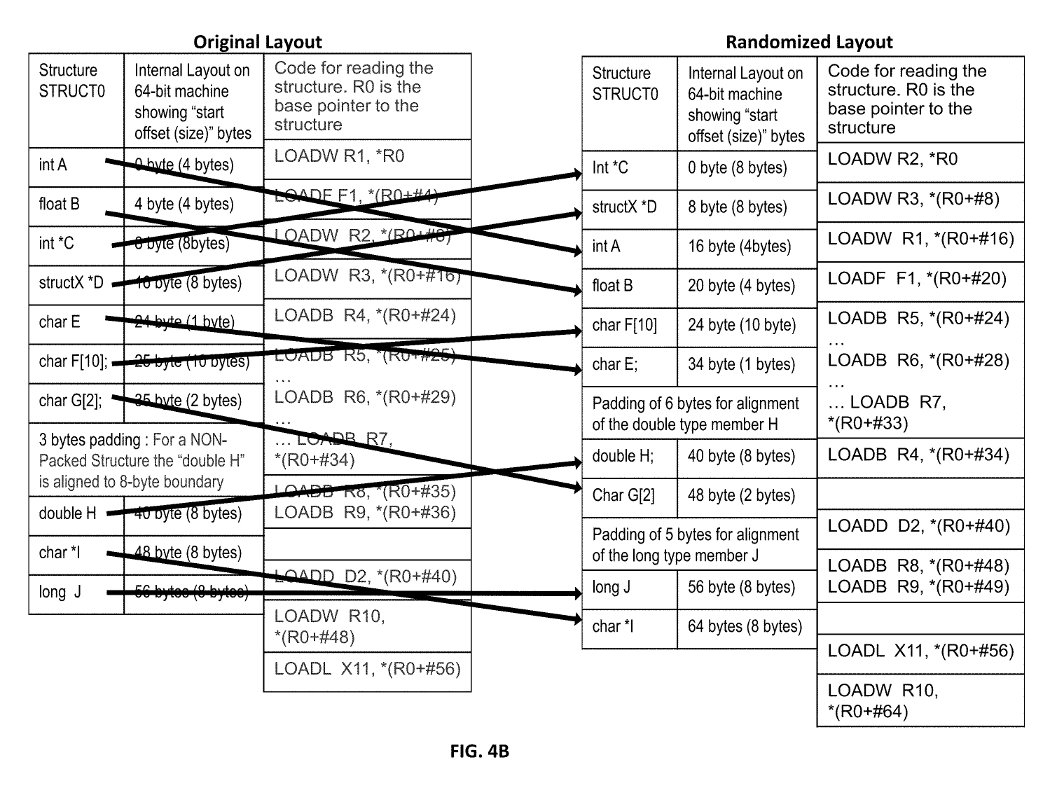

The metadata generation unit 270 provides means for performing the various example implementations discussed herein unless otherwise specified, such as the techniques illustrated in at least FIGS. 4-14. For example, the metadata generation unit 270 can provide the means for identifying one or more randomizable components in the source code for which the layout of the elements of the one or more randomizable component is to be randomized, and means for generating metadata that includes layout information for the one or more randomizable components for which the layout of the elements of the data is to be randomized. The one or more randomizable components comprise one or more data structures, one or more objects, one or more data sections in the image file, or a combination of two or more of these. In some implementations, the functionality of the metadata generation unit 270 can be implemented by the compiler 230.

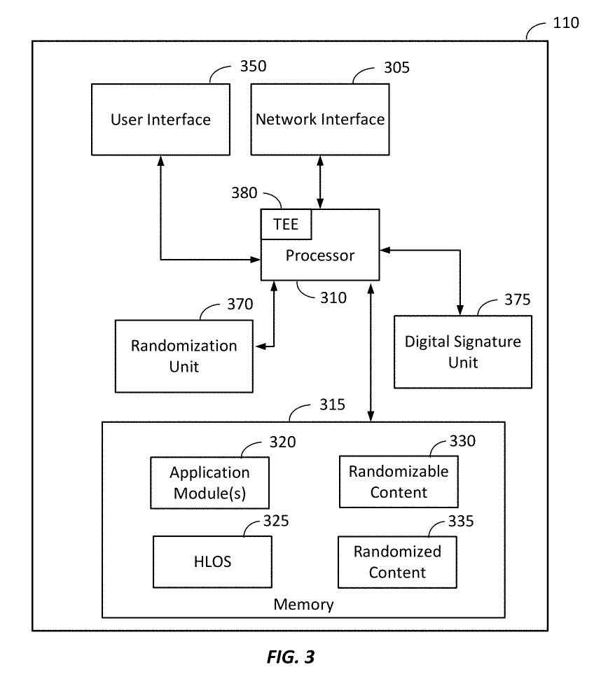

FIG. 3 is a functional block diagram of an example computing device 300 that can be used to implement various computing devices disclosed herein, such as the client device 110 discussed in the preceding example implementation. For the sake of simplicity, the various features/components/functions illustrated in the schematic boxes of FIG. 3 can be connected using a common bus or are can be otherwise operatively coupled together. Other connections, mechanisms, features, functions, or the like, may be provided and adapted as necessary to operatively couple and configure a computing device 300. Furthermore, one or more of the features or functions illustrated in the example of FIG. 3 may be further subdivided, or two or more of the features or functions illustrated in FIG. 3 may be combined. Additionally, one or more of the features or functions illustrated in FIG. 3 may be excluded.

As shown, the computing device 300 can include a network interface 305 that can be configured to provide wired and/or wireless network connectivity to the computing device 300. The network interface can include one or more local area network transmitters, receivers, and/or transceivers that can be connected to one or more antennas (not shown). The one or more local area network transmitters, receivers, and/or transceivers comprise suitable devices, circuits, hardware, and/or software for communicating with and/or detecting signals to/from one or more of the wireless local area network (WLAN) access points, and/or directly with other wireless computing devices within a network. The network interface 305 can also include, in some implementations, one or more wide area network transmitters, receivers, and/or transceivers that can be connected to the one or more antennas (not shown). The wide area network transmitters, receivers, and/or transceivers can comprise suitable devices, circuits, hardware, and/or software for communicating with and/or detecting signals from one or more of, for example, the wireless wide area network (WWAN) access points and/or directly with other wireless computing devices within a network. The network interface 305 can include a wired network interface in addition to one or more of the wireless network interfaces discussed above. The network interface 305 can be used to receive data from and send data to one or more other network-enabled devices via one or more intervening networks.

The processor(s) 310 may be connected to the memory 315, the randomization unit 370, the digital signature unit 375, the user interface 350, and the network interface 305. The processor may include one or more microprocessors, microcontrollers, and/or digital signal processors that provide processing functions, as well as other calculation and control functionality. The processor 310 may be coupled to storage media (e.g., memory) 315 for storing data and software instructions for executing programmed functionality within the computing device. The memory 315 may be on-board the processor 310 (e.g., within the same integrated circuit package), and/or the memory may be external memory to the processor and functionally coupled over a data bus. The memory 315 can comprise volatile memory, persistent memory, or a combination thereof

A number of software modules and data tables may reside in memory 315 and may be utilized by the processor 310 to manage, create, and/or remove content from the computing device 300 and/or perform device control functionality. Furthermore, components of the high-level operating system (“HLOS”) 325 of the computing device 300 may reside in the memory 315. As illustrated in FIG. 3, in some embodiments, the memory 315 may include an application module 320 which can implement one or more applications. It is to be noted that the functionality of the modules and/or data structures may be combined, separated, and/or be structured in different ways depending upon the implementation of the computing device 300. The application module 320 can comprise one or more trusted applications that can be executed by the trusted execution environment 380 of the computing device 300.

The application module 320 may be a process or thread running on the processor 310 of the computing device 300, which may request data from one or more other modules (not shown) of the computing device 300. Applications typically run within an upper layer of the software architectures and may be implemented in a rich execution environment of the computing device 300, and may include games, shopping applications, content streaming applications, web browsers, location aware service applications, etc. The application module 320 can be configured to comprise one or more applications that can be executed on the computing device 300. The application module 320 and/or the HLOS 325 can be updated, at least in part, based on the image files that are received from the source device 105 and/or the content provider 120.

The processor 310 can optionally include a trusted execution environment (TEE) 380. The trusted execution environment 380 can be used to implement a secure processing environment for executing secure software applications. The trusted execution environment 380 can be implemented as a secure area of the processor 310 that can be used to process and store sensitive data in an environment that is segregated from the rich execution environment in which the operating system and/or applications (such as those of the application module 320) may be executed. The trusted execution environment 380 can be configured to execute trusted applications that provide end-to-end security for sensitive data by enforcing confidentiality, integrity, and protection of the sensitive data stored therein. The trusted execution environment 380 can be used to store encryption keys, authentication information, and/or other sensitive data. The trusted applications may also be used to conduct financial transactions, access sensitive data (e.g. medial or financial data associated with user of the device or with proprietary information associated with a company with which the user of the device works), and/or perform other operations of a sensitive nature. In some implementations, some or all of the functionality associated with the trusted applications may be implemented by untrusted applications operating in a rich execution environment of the computing device 300. The TEE 380 can be configured to implement, at least in part, the randomization unit 370 and/or the digital signature unit 375. The randomization unit 370 and/or the digital signature unit 375 can be implemented as executable program code that is executed by the TEE 380.

The computing device 300 may further include a user interface 350 providing suitable interface systems for outputting audio and/or visual content, and for facilitating user interaction with the computing device 300. The computing device 300 may include additional user interface components, such as a keypad and/or a touchscreen for receiving user inputs, and a display (which may be separate from the touchscreen or be the touchscreen) for displaying visual content.

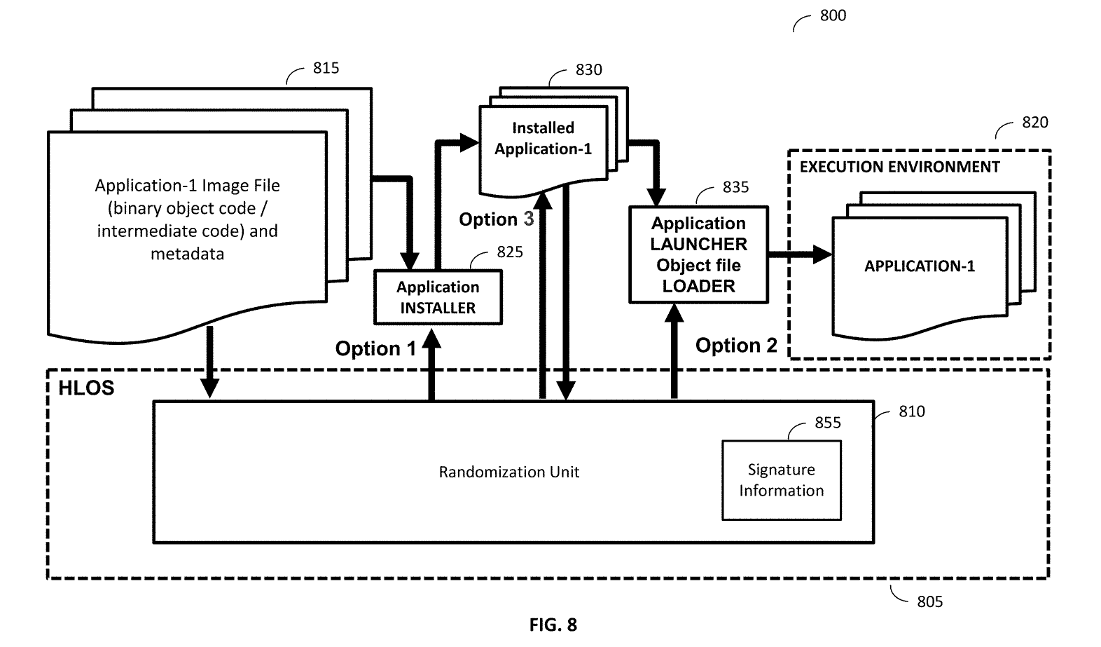

The randomization unit 370 can provide means for performing the various example implementations discussed herein unless otherwise specified, such as the techniques illustrated in FIGS. 8 and 14-18 and other example implementations discussed herein. The randomization unit 370 can be configured to randomize one or more one or more randomizable components including one or more data structures, one or more objects, one or more data sections in the image file, or a combination of two or more of these randomizable components included in binary object code and/or intermediate code included in image files received from the source device 105. The randomization unit 370 can randomize randomizable content 330 stored in the memory 315 of the client device 110 to generate randomized content 335. The randomized content 335 can include one or more randomized image files. The randomized content 335 can be installed on and/or executed by the client device 110.

The digital signature unit 375 can provide means for signing randomized image files. The digital signature unit 375 can also be configured to digitally sign the randomized content 335 generated by the randomization unit 370 when either integrity protection is needed, or the original binary object code or intermediate code was signed, and integrity protected. The digital signature unit 375 can be configured to sign the randomized image files using a device-specific cryptographic key. In implementations when the image file is signed, the randomization can be performed by the randomization unit 370 after a signature verification is performed by the digital signature unit 375. For implementations when the randomized image file is saved for future use a new signature can be created replacing the original signature on the original binary file. The device-specific cryptographic key can be managed by the TEE 380 and/or by the processor 310. The device-specific cryptographic key can be managed by the client device 110 such that the device-specific cryptographic key is inaccessible to untrusted applications. The digital signature unit 375 can be configured to sign randomized image files that resulted from image files which were signed by the source device 105 and/or the content provider 120. Alternatively, the digital signature unit 375 can be configured to sign all randomized image files generated by randomization unit 370. The new signature can be generated using the device-specific cryptographic key, a hash function available in the device, and the modified binary resulting from the randomization of the layout of one or more randomizable components identified in the metadata associated with the image file. The new signature can be verified using the public key of the device that matches the private key used to sign the randomized image file when the randomized image file is loaded by the client device 110 for execution. Since the new signature is done in a secure component of the client device 110, the newly signed randomized image file can be considered to be integrity verified. Alternatively, device specific symmetric keys can also be used to encrypt and decrypt the new randomized binary. Device specific symmetric keys could also be used to provide authenticated encryption of the randomized binary, which combines symmetric encryption and checked integrity (using Message Authentication Code, i.e., MAC). These modes ensure both confidentiality and integrity

The randomization can be performed by the randomization unit 370 at the time that the image file is installed on the client device 110 and/or at the time that the binary object code or intermediate code from the image file is loaded for execution by the client device 110. The randomization can also be scheduled to be performed periodically on randomizable content 330 stored in the memory 315 of the client device 110. The randomizable content 330 can comprise original content that may have been received in one or more image files. The randomizable content 330 can include binary object code and/or intermediate code that can include one or more data structures or objects that are identified as randomizable in the metadata that we received with the image file. The image files may also include one or more data sections that are randomizable that are also identified in the metadata. The randomizable content 330 may be stored in a portion of the memory 315 that is accessible to the randomization unit 370 and the digital signature unit 375 but may be inaccessible to other applications operating on the client device 110. The randomization unit 370 can randomize the randomizable content 330 and store the randomized content 335 in the memory 315 of the client device 110.

When the randomization is performed at the time that the binary code or intermediate code is installed on the computing device and the image file is digitally signed, the signature verification can first be performed by the digital signature unit 375, and the randomization unit 370 can be configured to randomize the binary code and to install the randomized binary code on the computing device responsive to the signature verification is successful. The original image file may be stored as randomizable content 330 and the randomized binary code and/or intermediate code may be stored as randomized content 335. The processor 310 of the client device 110 may execute binary object code and/or intermediate code from the randomized content 335.

When the randomization is performed at the time that the binary object code or intermediate code is loaded and the image file is digitally signed, the signature verification can first be performed on the digitally signed content by the digital signature unit 375, and the randomization unit 370 can be configured to randomize the binary code or intermediate code and to load the randomized binary object code or intermediate code on the computing device if the signature verification is successful. For kernel and bootloader images and certain signed applications, the signature verification can first be performed on the image file by the digital signature unit 375, and the randomization unit 370 can be configured to randomize the layouts of randomizable components present in the binary code, resulting in a randomized image file (which may be stored in the randomized content 335), and to load the resulting randomized image file for the bootloader, kernel, or application on the computing device if the signature verification is successful. For cases when the randomized image file is saved for future use (e.g. in the randomized content 335), a new signature can be created replacing the original signature. The new signature can be generated using digital signature unit 375 with a device specific private key, a standard hash function available to the digital signature unit 375, and the randomized image file. The new signature can be verified using the public key of the device (for the matching private key used to sign) when the randomized image file is loaded the next time. Since the new signature is done in a secure component of the client device 110, the signed randomized binary can be considered integrity verified. Alternatively, device specific symmetric keys can also be used to encrypt and decrypt the new randomized binary. Device specific symmetric keys could also be used to provide authenticated encryption of the randomized binary, which combines symmetric encryption and checked integrity (using Message Authentication Code, i.e., MAC). These modes ensure both confidentiality and integrity.

Performing the randomization on the computing device allows the same binary image to be used for multiple devices. Each device will have a different layout for the randomizable components in which accesses to the same members/fields/elements of the randomizable components will have different offsets in the binary object code and/or intermediate code installed on different devices. This approach increases entropy and can drastically reduce the chance of an attacker making a wide-spread attack exploiting the known layout information for the widely distributed binary image. Furthermore, when the randomization is done at application load time before execution, it's further possible to have different layouts and access offsets during each instance of application execution. The use of on-device randomization of the layout of structures included in the binary code does not add any execution overhead like some conventional methods for randomization, because no software framework or manager is built into the randomized binary code.

FIGS. 4A and 4B illustrate an example of randomization that can be implemented using the techniques disclosed herein. The example illustrated in FIGS. 4A and 4B is a data structure or aggregate, but the techniques disclosed herein can be implemented one or more data structures, one or more objects, one or more data sections in the image file, or a combination of two or more of randomizable components included in binary object code or intermediate code. FIGS. 4A and 4B are identical, except that FIG. 4B includes arrows that illustrate where various elements have been relocated as part of the randomization process. The left side of FIGS. 4A and 4B illustrate an original layout of an example data structure included in binary code that may be randomized using the techniques disclosed herein and the right side of FIGS. 4A and 4B illustrate the structure after randomization has been performed. The example data structure illustrated in FIGS. 4A and 4B is merely an example of one such structure that can be randomized using the techniques disclosed herein and is not intended to limit the techniques disclosed herein to this particular example. Furthermore, the example illustrated in FIGS. 4A and 4B is shown with only LOAD instructions for performing a read access of the data structure. STORE instructions could be used to writing data to the data structure. In a typical implementation of a data structure, both LOAD and STORE instructions (or equivalent instructions depending upon the particular implementation) will typically be spread throughout the program code depending upon what data is accessed and/or written in the application and when such actions occur.

The original layout of the structure depicted on the left side of FIGS. 4A and 4B comprises three columns of information. The elements comprising the structure are listed in the leftmost column (e.g. integer, float, double, integer pointers, character arrays, etc. in this example). The is also 3-bytes of padding included in the structure so that the “double H” is aligned to the 8-byte boundary. Such padding must be accounted for by the randomization techniques disclosed herein may also cause the size of a randomizable component to change once randomized as illustrated in this example. The offsets and the sizes associated with each of the elements are illustrated in the center column. The rightmost column includes example code for reading the structure illustrated in this example. The code references the offsets associated with each of the elements to read the data associated with that particular element.

The randomized layout of the structure depicted on the right side of FIGS. 4A and 4B also comprises three columns of information. The order of the elements comprising the structure are listed in the leftmost column (e.g. integer, float, double, integer pointers, character arrays, etc. in this example) after the randomization process has been applied. The new offsets associated with each of the elements is illustrated in the center column. The rightmost column includes example code for reading the structure. The code references the updated offsets associated with each of the elements to read the values associated with that particular element. Also, padding was introduced at two locations in the randomized structure so that elements of the structure are aligned along required 8-byte boundaries. After randomization, six bytes of padding is introduced before the “double H” element (in contrast with the three bytes of padding introduced in the original structure) and five bytes of padding is introduced before the “long J” element to ensure that the “long J” element aligned with the 8-byte boundary.

In the randomization techniques disclosed herein, the randomization of the randomizable components, such as that illustrated in FIGS. 4A and 4B occurs on a computing device on which the binary object code is being installed, such as the client device 110. The randomization is done independently for each computing device at the time that the code is being installed on the computing device, when the binary code is loaded to be executed by the computing device, for system and driver binaries when the boot-loading process happens, when an application using the binary code is being un-used on the computing device, or a combination thereof. The randomization introduced into the randomizable components can be used to protect sensitive data stored therein and to make it more difficult for an attacker to determine the layout of a particular data structure, object, data sections in the image file, or a combination of two or more of such randomizable components.

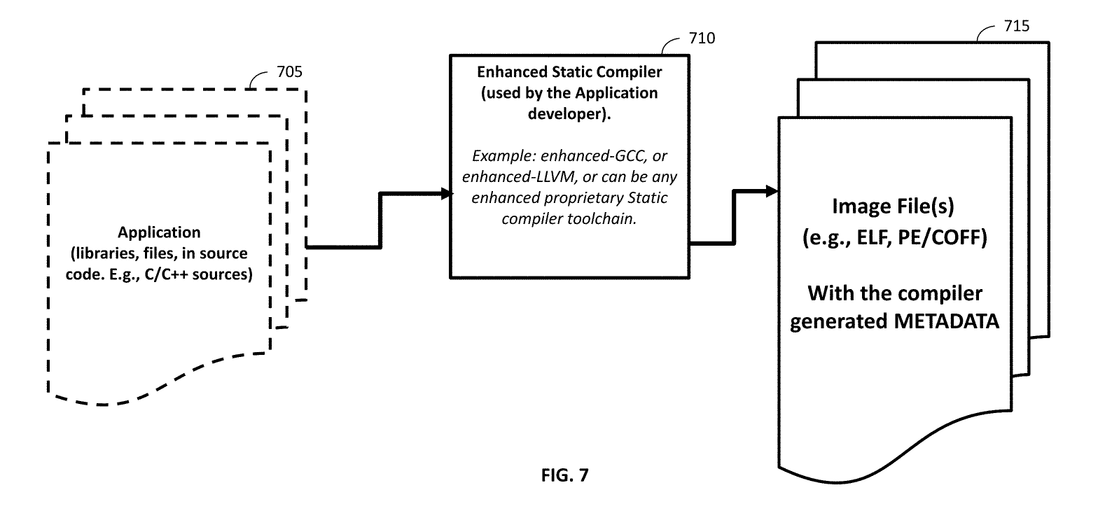

FIG. 7 is a high level schematic diagram illustrating the functional components of an example of a compiler that can be used by an application developer to implement the techniques disclosed herein. The source code 705 for an application can be implemented in various programming languages. As discussed above, the source code 705 can be tagged or otherwise annotated by the application developer to identify structures for storing sensitive data that should be randomized. The specific means for tagging or annotating the source code may vary depending upon the programming language or languages utilized and/or other considerations. The compiler 710, which can be used to implement the compiler 230 of the source device 105, is configured to generate image file(s) 715 based on the source code 705. The image file(s) 715 include metadata describing one or more randomizable components included in the binary program code whose layout are to be randomized by the randomization unit 370 of the client device 110 on which the image file(s) 715 are to be installed. As discussed above, the image file(s) 715 can be stored in various object file formats, and the compiler can be configured to insert the metadata into a predetermined location of the image file(s) 715 or to provide the metadata as a separate file or files with the image file(s) 715.

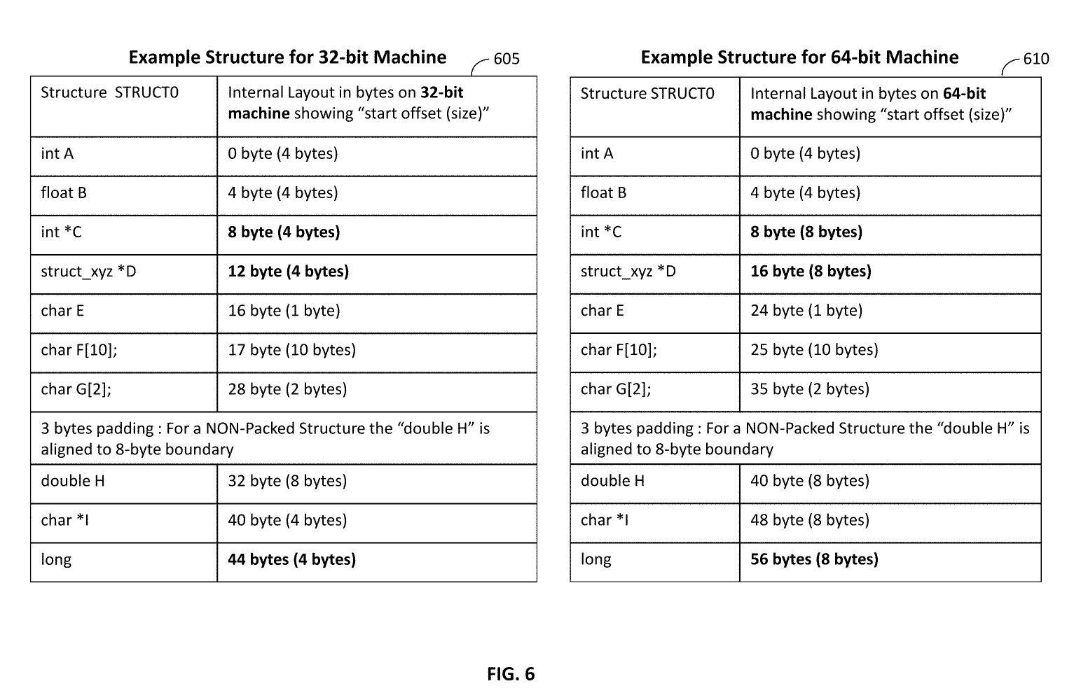

FIG. 6 illustrates an example structure 605 for a 32-bit machine (on the left) and an example structure 610 for a 64-bit machine (on the right). FIG. 6 illustrates that some elements of the structure can vary depending upon whether the binary is for a 32-bit machine versus a 64-bit machine. For example, the pointer sizes, certain data type sizes (e.g., the “long” data type) can vary depending on whether the structure is intended for the 32-bit machine versus the 64-bit machine. These differences would result in different internal offsets in the data structure as can be seen in the examples illustrated in FIG. 6. For example, the pointers and the long data type in the 32-bit example structure 605 are 4 bytes long and the pointers and the long data type in the 64-bit example structure 610 are 8 bytes long. The metadata generated by the compiler 230 reflects the order and size of each of the elements of the structure.

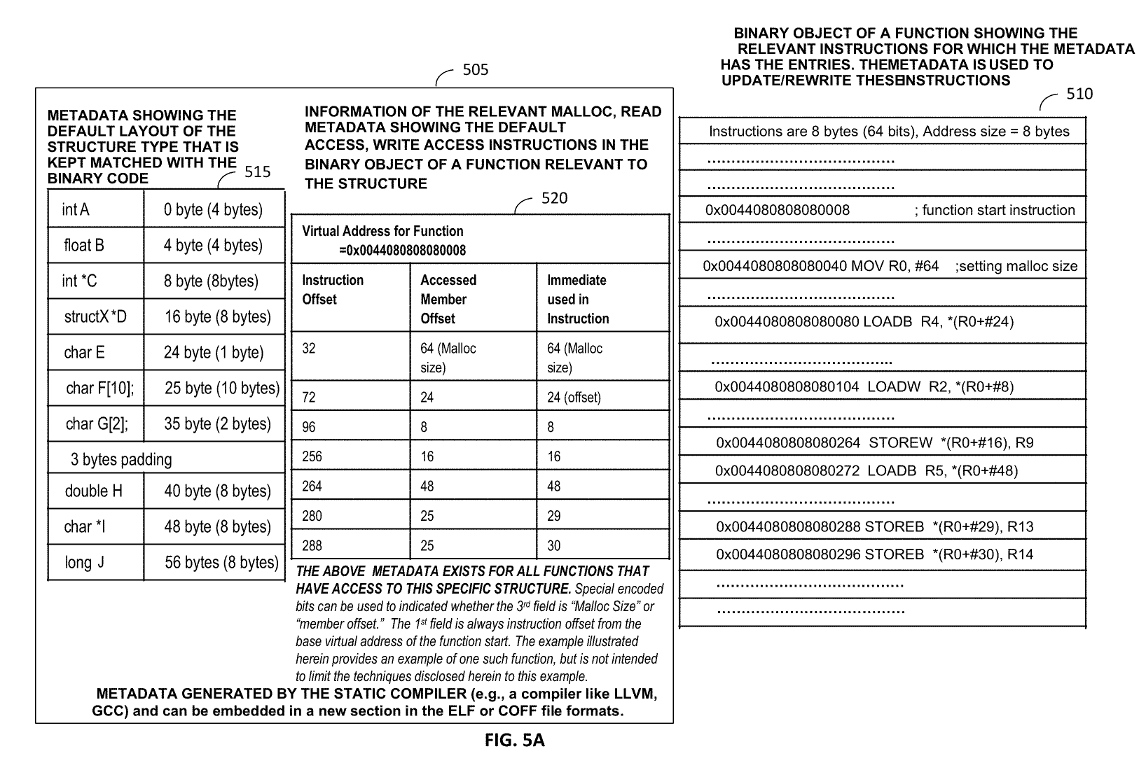

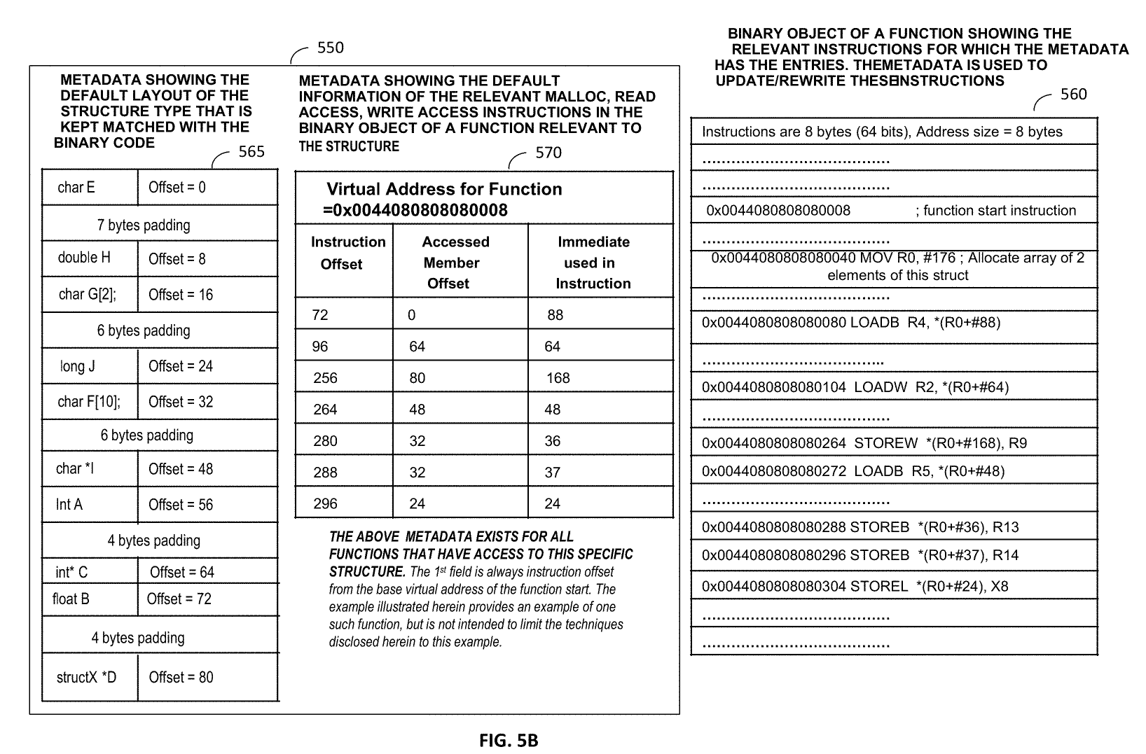

The 64-bit example structure 610 of FIG. 6 is used in the FIGS. 5A and 5B to illustrate examples of binary object code and metadata being generated by the compiler 230. The metadata generated by the compiler 230 provides information about the structure layout including the elements of the structure. The metadata can include the virtual address of assembly code instructions that access the structure elements or allocates instances of the structure. FIG. 5A and 5B are diagrams illustrating this concept. While the examples illustrated in FIGS. 5A and 5B operate on a structure included in binary object code, the same concepts can be applied to objects and/or other aggregate data structure and can also be applied to intermediate code. FIG. 5A illustrates example metadata 505 that illustrates the types of information that can be included in the metadata for the example binary object code 510, and FIG. 5B illustrates example metadata 550 that illustrates the type of information that can be included in the metadata for the example binary object code 560. The examples illustrated in FIGS. 5A and 5B include different layouts for the same structure type, and the example illustrated in FIG. 5B is an example of a maximal-sized layout for the structure type. Thus, FIG. 5B shows that configuration the layout that represents a largest possible size the structure would have among the possible ways of arranging the elements of the structure type in its layout, without adding any unneeded empty fields. The maximal-sized layout incorporates all needed padding fields to maintain alignment constraints of the individual member types and to satisfy the programmer specific constraints as it tries all possible combinations of member field placement in the layout. The particular combination of member field layout, with the necessary padding field to satisfy alignment and programmer specific constraints, that leads to the largest size of the layout is the maximal sized layout. Accordingly, this represents what would be the maximum possible size among all possible cases when layout randomization would be done later on-device by the client device 110. While the example illustrated in FIGS. 5A and 5B have a single maximal-sized layout, a structure or other randomizable component may have more than one layout of the maximal size for the structure or other randomizable component depending upon the elements included in the structure or other randomizable component. The randomization unit 370 of the client device 110 can make the determination as to which layout of the structure will be used when the structure is randomized. The compiler 230 is concerned with allocating a sufficient size for the structure to accommodate the maximal-sized layout.

The compiler 230 can select and allocate the maximal-sized layout for the structure, so that the randomization module 370 of the client device 110 need not worry about any increase in allocated size for the structure type when randomizing the layout of the structure. If the randomization unit 370 comes up with a layout whose size is smaller than the maximal layout, the randomization unit 370 can fill the additional space by padding. Padding is unused memory that can be inserted between elements of the elements/fields/members of the structure being randomized. The metadata can include a default layout of the structure that identifies the structure layout, including each of the elements of the structure and the data types of each of these elements. The metadata can also identify any padding that has been added to the structure to ensure that one or more members of the structure line up with a particular byte boundary (as previously discussed with respect to FIGS. 4A and 4B). The metadata also includes information identifying functions that have any access to any instances of the particular structure type in the binary object code 510 whose layout can potentially be randomized on-device. Functions that allocate memory for the structure, read instructions that read any of the elements from the structure, and write instructions that write to any of the elements of the structure can be identified in the metadata. The metadata can include a virtual address that denotes the first instruction of the function (also referred to herein as a “base address”), an instruction offset that indicates the offset from the virtual address of the first instruction of the function, and an offset value into the data structure from which an element is to be read or an element is to be written or a size value for allocating memory for an instance of the structure. The metadata can be used by the randomization unit 370 of the client device 110 to update and/or rewrite the instructions in the binary object code 510 once the structure/aggregate layout has been randomized by the randomization module so that the offsets used by the functions match those of randomized layout of the structure. Randomization can result in the various offset values discussed above needing to be updated to reflect the new order of the members/fields/elements of the structure. Also, the size of the structure may change as a result of the randomization as was illustrated in FIGS. 4A and 4B due to the need to introduce padding (or earlier padding becoming redundant) into the structure so that certain elements of the structure align on byte boundaries or satisfy the programmer specified constraints.

The compiler 230 can be configured to analyze the program code for safety of the randomization. A programmer may inadvertently flag or annotate a structure or object for layout randomization that could potentially cause problems, such as randomizing the layout of a structure that may be exposed to external interfaces which would break external references to the structure because these references would not also be updated to match the randomized data structure. The compiler 230 can be configured to use a set of rules to determine which structure types and/or specific structures are safe to randomize. Structures or objects that are purely internal and are not exposed to external interfaces should be able to be randomized. The rules may be the same as those that could be using compile-time structure layout randomization (but such randomization is not performed in the compiler in the techniques disclosed herein).

The compiler 230 is configured to defer the decision whether to randomize a particular structure until the image file comprising the binary object code and/or intermediate code has been deployed to the client device 110. The compiler 230 can decide on multiple implementation strategies for code transformation and static layout transformation of the structure or objects included in the program code being compiled, such that the on-device randomization becomes simpler with reduced constraints and more flexibility when done on device. The compiler 230, after its analysis, emits code where the binary object code or intermediate code is not using the exact layout for the structure as specified by the programmer, but instead includes a transformed form for which it is easy to perform on-device randomization at the client device 110. In some implementations, the compiler 230 can calculate a layout that produces maximum structure or object size originating from alignment/padding constraints and uses that layout as the default layout (even if different from the source code specification) for the default binary object code and/or intermediate code that the compiler 230 emits. Subsequently, the randomization unit 370 of the client device 110 can choose any legal randomized layout of the structure or object that is legal. If the resulting randomized layout happens to be smaller than then maximum size layout selected by the compiler 230, then the randomization unit 370 can add padding to the randomized structure or object. In instances where the compiler determines that there are multiple maximum sized layouts that can be selected for a particular structure or object, the compiler 230 can be configured to randomly selected one of these layouts for the default layout of the structure or object that will be included in the image file and the metadata generated by the compiler 230. As shown in the example metadata of FIGS. 5A and 5B the compiler can include the following metadata sections: (1) a structure layout information section (section 515 in FIG. 5A and section 565 in FIG. 5B) that can include an element identifier, a default offset for the element, an element size, and alignment requirements (if any); and (2) an offset patch table (section 520 in FIG. 5A and section 570 in FIG. 5B) including an instruction offset for each instruction that requires patching, an accessed element (or member) offset of the element accessed by the instruction, and an immediate used in the function that requires patching. In other implementations, the contents of the metadata can vary from those included in the examples of FIGS. 5A and 5B. Other implementations can include other information in addition to or instead of one or more of the sections discussed above.

The compiler 230 can also be configured to provide support for one or more of the following features: (1) the randomized structure or other randomizable component can be used as an element of another structure, object, or other aggregate data structure and can be stored in arrays, vectors, and/or other types of data structures; (2) the randomized structure or other randomizable component can include composite elements (e.g. other structures, arrays, etc.); (3) templates for C++ and/or other object-oriented programming languages can be used with the techniques disclosed herein (a template parameter can be passed to a structure, object, or other aggregate data structure that is randomized and/or a randomized structure, object, or other aggregate data structure can be passed to another structure, object, or other aggregate data structure as a template parameter); and (4) randomization can be limited to private elements of randomizable components to avoid changing public elements that may be relied upon by other program code.

The randomization unit 370 of the client device 110 can determine that layout randomization should not be performed on some or all of the structures or objects included in the image file in some instances. The randomization unit 370 can be configured to identify a library or an application on the computing device that creates an external dependency on a non-randomized structure or object included in the image file or to identify other factors on the client device 110 that would preclude randomization of one or more structures or objects in the image that were identified in the metadata as being randomizable.

An example of the steps that are performed by the randomization unit 370 for can include: (1) the linker of the randomization unit 370 consolidating metadata from different object files; and (2) the randomization unit 370 modifying the instruction addresses and emit errors if inconsistencies are detected. At installation and/or before execution of the binary object code or intermediate code, the loader of the randomization unit 370 can perform the following: (1) reading structure and/or object layout information from the metadata; (2) randomly calculating a new layout for the structure and/or object that satisfies alignment requirements included in the metadata; (3) storing new element offsets in a randomizable component information table; and (4) and updating the offset patch table (discussed above with respect to FIGS. 5A and 5B). For each instruction in the offset patch table, the randomization unit 370 obtains the base or the starting offset (“O”) for the object (which is the same as the offset value for the first member of the object in it's layout), uses the accessed member offset (“D”) and calculates a new offset (“N”) for the instruction being patched where N=O−D+P, where “P” represents the new accessed member offset for the element of the randomized randomizable component. Each instruction can be patched with the new offset resulting from the randomization of the randomizable component.

FIG. 8 is a schematic diagram illustrating an example implementation of the logical components of a computing device 800 according to the disclosure. The computing device 800 can be used to implement the client device 110 illustrated in FIGS. 1 and 3. In the example illustrated in FIG. 8, the randomization unit 810 is implemented as part of the high-level operating system (HLOS) 805. However, as previously discussed in FIG. 3, the randomization unit can be implemented as software, hardware, or a combination thereof that can be separate from the HLOS of the computing device. The HLOS 805 can provide similar functionality as that of HLOS 325, and the randomization unit 810 can provide similar functionality as that of the randomization unit 370. The randomization unit 810 can be implemented in the kernel of the HLOS 805, and thus, be protected from other applications that are being executed on the computing device 800. Furthermore, the computing device 800 may include a trusted execution environment similar to that of TEE 380 in which the randomization unit 810 can be implemented as a trusted application. The program code for the randomization unit 810 can be stored in a non-transitory computer readable medium of the computing device that is similar to that of the memory 315 of the client device 110. The non-transitory computer readable medium can comprise various types of persistent memory that can store the program code on the computing device. The computing device can comprise one or more processors that can execute the program code stored in the computer readable medium similar to the processor 310 of the client device 110.

The computing device 800 can also include an application installer 825 and an application launcher 835. The application installer 825 can be configured to install applications on the computing device 800 that are included in the image file(s) 815. The application launcher 835 can be configured to launch applications on the computing device 800 that are included in the image file(s) 815. The application installer 825 and the application launcher 835 are configured to communicate with the randomization unit 810 and can be configured to install and launch applications from randomized versions of the image file(s) 815. The application installer 825 and the application launcher 835 can be implemented as software, hardware, or a combination thereof. The application installer 825 and the application launcher 835 can be implemented by the kernel of the HLOS 805. The application installer 825 and the application launcher 835 can also be implemented as trusted applications operating in a trusted execution environment of a processor of the computing device 800.

The image file(s) 815 are generated by the compiler 230 of the source device 105, such as the image file(s) 715 illustrated in FIG. 7. The image file(s) 815 include the metadata generated by the modified compiler or the metadata may be provided as a separate file or files associated with the image file(s) 815. The randomization unit 810 can be configured to implement layout randomization of randomizable components in the image file(s) 815 through one or more of these options: (1) at the time that the code is being installed on the computing device, (2) when the binary object code or intermediate code from the image file(s) 815 is loaded to be executed by the computing device (e.g. shared object files “<file>.so”) in response to an application using the binary object code and/or intermediate code is launched, and (3) any idle or non-usage time of the application, (4) during boot-loading process, or a combination thereof. With respect to option 1, the application installer 825 can be configured to receive a randomized version of the image file(s) 815 from the randomization unit 810, which the application installer 825 can install on the computing device 800 as installed application 830. In one implementation, the randomization unit 810 can be configured to store updated metadata indicative of the modifications that were made to the layout of the structure(s) included in the binary object file(s) in a persistent memory of the computing device. The updated metadata can be used by the randomization unit 810 to randomize the layout of the structure(s) of the randomized image file(s) installed on the device as installed application 830 or to randomize the image file(s) 815 again using a different randomization. In other implementations, the original metadata and the original binary code are stored in the device to be used for future randomization, such as the randomizable content 330 of the client device 110. The entire original binary need not be stored in this particular implementation, only parts of the original binary, specifically those functional modules where there are accesses to the instances of the randomizable components whose layout are randomized, need to be stored.

The application launcher 835 and the randomization unit 810 can be configured to handle implementations that utilize dynamic linking. In such implementations, the binary object code or the intermediate code associated with the application may be randomized just prior to loading by the application launcher 835 or may be preemptively randomized before any of the binary object code or intermediate code that may be utilized by the application is loaded by the application launcher 835. The application launcher 835 can be configured to instruct the randomization unit 810 to access the metadata associated with binary object code and/or the intermediate code associated with an application that is be launched prior to the application launcher 835 loading the binary object code from a persistent memory of the computing device. The application launcher 835 can be configured to provide the randomization unit 810 with information identifying binary object code and/or the intermediate code that is to be loaded by the application launcher 835 or that may be required for execution of an application. The randomization unit 810 can be configured to determine a randomization for the randomizable components included in the libraries, other binary object code, and/or intermediate code associated with the application to be loaded by the application launcher 835 and to generate randomized binary object code and/or intermediate code. The randomization unit 810 can be configured to preemptively randomize the object code for all libraries that may be utilized by application or can be configured to only randomize the libraries, other object code, and/or intermediate code as the object code or intermediate code is loaded by the application launcher 835.

The randomization unit 810 can also be configured to perform layout randomization on randomizable components to periodically generate new randomized image file(s) from the image file 815 while the client device 110 is experiencing an idle period (option 3 discussed above) or in response to a threat or intrusion to the device being detected. The randomized or re-randomized image file(s) can be stored in a persistent memory of the client device 110, which may be part of memory 315, as randomized content 335 and can replace the randomized image file(s) that were previously stored as randomized content 335 in a persistent memory of the computing device, which may be a portion of the memory 315 of the client device 110. Periodically re-randomizing the image file(s) 815 can increase the security of the computing device by causing any exploits that may have been found that worked for a previous version of the program code to fail due to the new randomized layout of the structures therein.

The computing device can include one or more alarms that can be triggered responsive to a tampering or other potentially malicious activity being detected. The triggering of such an alarm can cause the randomization unit 810 to re-randomize the image file(s) 815 used by the device to thwart any attempts that may have been in progress to gain access to sensitive information on the computing device or to gain control over at least a portion of the functionality of the computing device.

The randomization unit 810 can also be configured to perform randomization on the image file(s) responsive to the application launcher 835 loading the image file(s) for the installed application 830 for execution in the execution environment 820 of the computing device. The installed application 830 may have already been randomized at the time that the application was installed or may have been installed without randomization and the randomization may be performed at a later time (option 3) or at the time that the application is loaded (option 3).

The randomization unit 810 can be configured to select a specific randomization algorithm to be used for randomizing all the instances of one or more randomizable components each time that a randomization needs to be performed. The randomization unit 810 can include a random number generator or a pseudo-random number generator that can be used to generate a seed value that can be used to randomize a particular randomizable component. A different seed value may be selected for each type of randomizable component to be randomized in image file(s) 815 to be randomized.

The randomization unit 810 can be configured to perform a binary rewrite operation, write new offset values for each of the instructions in the image file(s) that utilize the randomized layout. The binary rewrite operation can include updating the allocated size for any instance of the randomizable component in the image file(s) 815. As discussed with respect to FIGS. 4A and 4B, the size of the structure may change as a result of the randomization. For example, additional padding may be required to be added (and existing padding removed or changed in size) to the randomizable component to satisfy alignment requirements of the elements of the structure or object. Additional padding may also be required to satisfy programmer specific constraints, which may alter the size of the structure. If the structure or object is allocated on the local stack of the computing device, the randomization unit 810 can be configured to adjust the stack allocation with the new size responsive to the size of the structure or object changing as a result of the randomization. All of the other stack allocation offsets may also need to be adjusted. The randomization unit 810 can also be configured to perform a binary rewrite on any immediate values of any instructions that are related to the structure or object size which changed as a result of the randomization.

The compiler 710 can be configured to calculate a maximum size for a structure or class based on alignment and/or padding constraints, and program specified attributes and constraints. The example structure sizes illustrated in FIG. 5B illustrates this concept. The compiler 710 has allocated such a larger maximum size in the example illustrate in FIG. 5B. The compiler 710 can be configured to use this maximum size for binary object code emitted by the compiler 710. The randomization unit 810 of the computing device 800 can be configured to generate a randomized layout that may be smaller than the maximum structure size and can fill the remaining space by padding. The randomization unit 810 can also spread the structure layout over the maximum structure size allocated by the compiler 710 in order to increase entropy of the randomized binary object code. Furthermore, using this maximum structure/aggregate size layout, only instructions in the randomized binary object code that access the randomized structure(s)/aggregate(s) require updates to utilize the randomized layout of these entities. While this example was applied to a structure, the compiler 710 can similarly determine a maximum size for an object or other types of aggregate data structures.

The compiler 710 can also be configured to select a layout size for a structure or object to be more than the maximum size discussed above by inserting additional padding between or after consecutive elements of the structure or object leading to a size that is more than the maximal layout size using the alignment, padding, and program attribute and constraints. This approach can provide for even greater entropy by allowing for larger freedom of movement and placement positions of the elements in the layout of the structure or object. This approach helps to increase entropy particularly when the size of a structure is small, but yet it is sensitive with respect to security issues. Such structures or objects when increased in size by adding redundancies through padding increases the chances of the randomization module of the computing device to randomize to a larger extent than what would have been possible through maximal layout size. The compiler 710 can be configured to perform the analysis to determine which randomizable components are suitable for such increased size (preferably smaller sized, but sensitive, and with small number of instances to prevent memory bloat). Thus, the compiler 710 can decide on the size of the structures or objects to be used while generating the binary, and the on-device randomizer does the randomization on the transformed structure type (i.e., increased in size) by the compiler.

The example layout illustrated in FIG. 5A is smaller than the maximal layout discussed above. In some implementations, the compiler 710 may utilize such a layout that is smaller than the maximal size. This approach can may provide somewhat less flexibility when determining the randomization of the layout but can reduce the amount of memory on the computing device on which the randomized binary object code is to be utilized. This approach can introduce entropy into the randomized binary object code while limiting the amount memory required to introduce the entropy into the randomized binary code.

Randomization can also be done when the binaries are signed and involves a signature verification step, e.g., signed applications, signed system components (kernel components/drivers) during application launching or during boot-loading. For signed binaries, the randomization is done after signature verification. The randomization unit 810 can be configured to implement the signature verification functionality or the computing device 800 can include a digital signature unit similar to digital signature unit 375. Additionally, the randomization unit 810 can be equipped with a secure infrastructure to generate an updated/new signature based on the new randomized binary using a device-specific private key (that the device may have in it's hardware fuses) and hash algorithm. The secure infrastructure in the randomization unit 810 is configured to swap out the old signature with the new signature so that the updated, randomized binary can be reused in the future loading processes before execution, until it decides to randomize again. Since the secure infrastructure verifies the previous (or the original for the first time) signature, the new signature generated by this method is considered authentic for the future loading processes. This approach avoids the overhead of randomization during every loading process and does the randomization for certain selected times. For all the new signatures on the modified binary after randomization, the key is the device's own private key (can be maintained in it's hardware fuses). For signature verification the device's own public key can be used to ensure that the secure infrastructure of the computing device made the changes to the signed binary object code. The randomization unit 810 can store the signature information 855 to track changes to the signature information that have been made by the randomization unit 810. Alternatively, device specific symmetric keys can also be used to encrypt and decrypt the new randomized binary. Device specific symmetric keys could also be used to provide authenticated encryption of the randomized binary, which combines symmetric encryption and checked integrity (using Message Authentication Code, i.e., MAC). These modes ensure both confidentiality and integrity.

The randomization unit 810 is configured such that if no metadata is present for the image file(s) 815, no randomization is performed on structures in the image file(s) 815. However, the randomization unit 810 can be configured to default to current conventional means for adding entropy increase security of the computing device. Furthermore, the randomization unit 810 may also employ one or more of these conventional means of randomization in addition to randomization of the layout of one or more randomizable components.

The randomization unit 810 and/or other components of the computing device can be configured to perform one or more conventional types of randomization that can provide some device-specific randomizations that can make it more difficult for an attacker to exploit weaknesses in various components of the computing device. One type of randomization is the randomization of binary executable program code by randomizing the sequence of program instructions. This approach can make it more difficult for an attacker to determine a location of functions are loaded into memory, which is similar to Address Space Layout Randomization (ASLR) but can provide a more fine-grained approach to randomizing modules of program code.

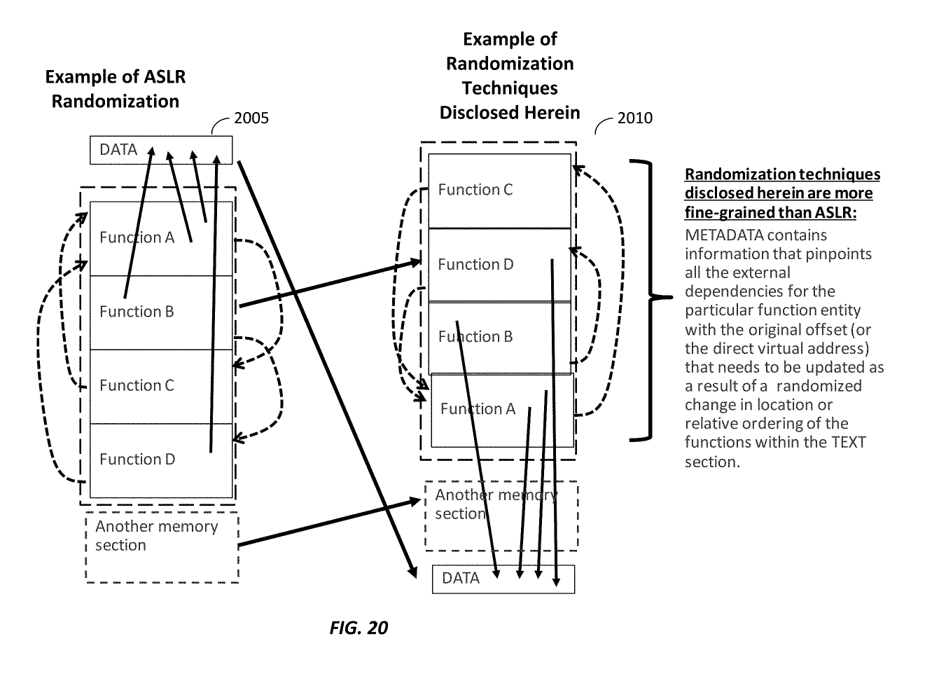

FIG. 20 is a diagram illustrating an ASLR-based randomization 2005 compared to a metadata-driven randomization 2010 using the techniques disclosed herein. The metadata-driven randomization provides a finer level of granularity than the ASLR-based randomization. For example, ASLR randomizes the location of the memory segments such as TEXT and DATA sections of the image file (i.e., the offsets of the .data and .text sections are randomized). ASLR is very coarse grained and packs all libraries and executable in the same order and without gaps. In contrast, the metadata-driven randomization approach disclosed herein can be extended to randomize the locations and order of the functions within a TEXT section by pointing the Address Immediate values that needs to be updated when such a location randomization and order change is made. Randomization of other sections of an image file can also be performed in some implementations.

Returning now to FIG. 8, if an attacker attempts to exploit an incorrect address space location, the program code being executed will crash, and the randomization unit 810 and/or other components of the computing device can be configured to monitor the execution of code for such events and can trigger various responses, such as rebooting the device, preventing the compromised application from being executed, and/or other preventative actions that can halt the attack. Another type of randomization that can be performed is randomization of the program stack layout at runtime. This randomization can be performed by the randomization unit 810 and/or other components of the computing device. The allocation of the stack variables can be randomized by randomizing the offsets of function variables from the stack pointer and rewriting the binary code of the function with the new randomized offsets before execution. These randomization techniques can be utilized alone, together, and/or in combination with one or more other randomization techniques. These techniques may also be utilized by the randomization unit 810 in addition to the metadata-based randomization techniques disclosed herein.

The conventional on-device randomization techniques, such as those discussed above, are only applicable to program code (e.g., ASLR) and the runtime program stack. These existing methods cannot be applied and do not work for on-device randomization of structure layout as is provided by the techniques disclosed herein. The metadata provided by the compiler with the image file(s) provide information regarding the structures included in the image file(s) that facilitate the randomization techniques disclosed herein. The randomization unit 810 must have access to the metadata and at least the portions of the image file(s) that include the original default binary code output by the compiler that includes the randomizable components to be randomized.

The compiler 710 and the randomization unit 810 can be configured to handle overflow situations that may occur with instructions that allow an immediate operand. An immediate operand comprises a constant value or the result of a constant expression. Immediate values can be encoded by the instruction at assembly time by the assembler. Instructions that allow an immediate operate typically have range constraints (e.g., [−138, 137]). The offset patching performed by the randomization unit 810 could potentially overflow (i.e., the new offset may be too large to fit into the instruction). The compiler 710 and/or the randomization unit 810 can be configured to handle this issue in one of the following ways discussed below.

A first solution to the overflow problem is that for each access to an element of a structure or object, the compiler 710 is configured to generate instructions that allow a largest offset value to fit into the instruction. This solution can simplify the randomization unit 810, which does not need to be configured to identify and account for such overflow conditions when updating the binary object code. Furthermore, this solution does not limit the possible layouts that may be generated. However, the resulting binary object code may be larger and/or may be slower to execute.

A second solution to the overflow problem is that the compiler 710 is configured to produce metadata in which a range constraint is attached to each element of the structure or object to be randomized. The randomization unit 810 is configured to produce a layout for the structure or object in which all range constraints and alignment constraints included in the metadata are obeyed. The randomization unit 810 can safely patch the binary object code or intermediate code included in an image file without introducing overflow issues. However, this approach may limit the number of possible layouts for the structure or object that the randomization unit 810 may utilize.

A third solution to the overflow problem is that the randomization unit 810 can be configured to handle an overflow by inserting extra instructions to load the large immediate operand. However, this solution requires that the randomization unit 810 be configured to include complex binary editing capabilities. More information may be required from the linker to properly update the binary object code.

These three solutions are examples of solutions that may be implemented by the compiler 710 and the randomization unit 810 to avoid such overflow errors. Furthermore, one or more of these solutions can be combined by the compiler 710 and/or the randomization unit 810. One solution may be applied to one or more elements of the structure or object while one or more other solutions may be applied to other elements of the structure or object. For example, the first solution may be applied to a first subset of the elements of a structure or object so that the first subset of the elements of the structure or object each have a largest offset value, and the second solution may be applied to a second subset of the elements of a structure or object so that each of the second subset of the elements are associated with range constraints. Other implementations can utilize other approaches to prevent this issue in addition to those discussed above. Furthermore, the example combination of approaches discussed above is not intended to limit the techniques disclosed herein to this particular combination of approaches. Other combinations are possible and within the scope of the disclosure.

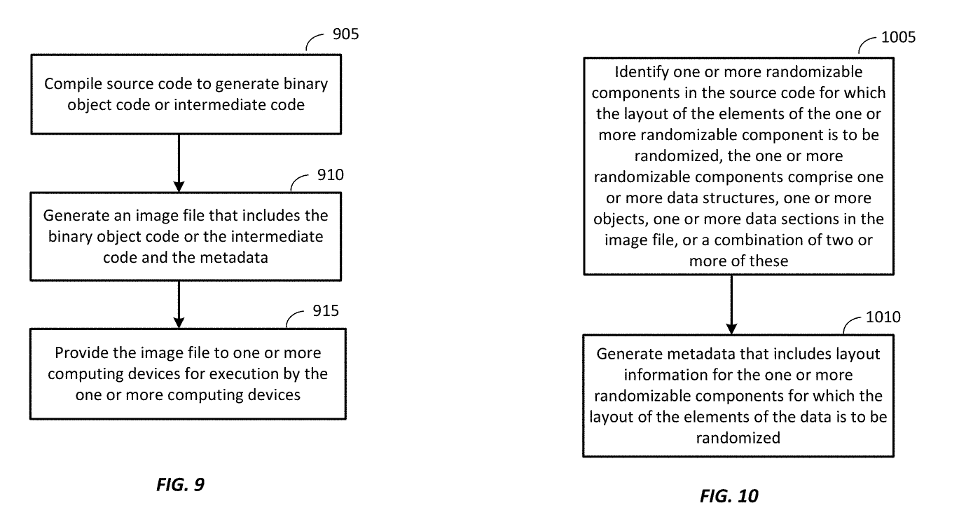

FIG. 9 is a flow diagram of an example process for generating executable code on a computing device according to the disclosure. The process illustrated in FIG. 9 can be implemented by the compiler 230 of the source device 105. While the discussion of the various stages refers to compiler 230, the compiler 710 illustrated in FIG. 7 can also be used to implement the process illustrated in FIG. 9.

Source code can be compiled to generate binary object code or intermediate code (stage 905). The source code can include one or more randomizable components including but not limited to data structures, objects, or other aggregate elements the layout of which can be randomized on the device on which the binary object code or intermediate code is to be deployed. The compiler 230 can be configured to recognize indicators or annotations that the programmer has included in the program code to identify data structures, objects, or other aggregate elements for which the layout can be randomized. A randomizable component can include one or more elements, members, or field (collectively referred to herein as “elements”) that can be used to store data within the randomizable component. Each element may be a primitive data type, such as but not limited an integer, floating point number, character, or string, or may be another type of data structure or object, which in turn may include one or more elements. The compiler 230 can be configured to identify such randomizable components and to generate metadata that described the layout of each of the randomizable components included in the program code. An example process for identifying the randomizable components and generating the metadata is illustrated in FIG. 10.

An image file can be generated that includes the binary object code or the intermediate code and the metadata (stage 910). The compiler 230 can be configured to generate an image file that includes the binary object code and/or the intermediate code the resulted from the compiling the source code. The image file can also include additional information, such as data sections, which include data that can be used by the binary object code and/or the intermediate code that was generated by the compiler 230. The metadata generated by the compiler can also be included in the image file or may be kept as a separate file or files associated with the image file.

The image file can be provided to one or more computing devices for execution by the one or more computing devices (stage 915). Alternatively, the image file can be provided to a content server, such as the content provider 120, which can distribute the image files to one or more computing devices, such as the client device 110. The client devices can use the metadata that is included in or included with the image file to randomize the layout of randomizable components of the image file. Such on-device randomization can provide a high level of security, because each client device can produce a randomized layout of the contents of the image file. If an attacker were able to determine an exploit that could be used against one version of the contents of the image file for a particular client device 110, the exploit would only work for that client device 110 or only on other client devices which happened to randomize the contents of the image file in an identical manner. This can significantly reduce the efficacy of an attack and force the attacker to have to work much harder to successfully a large number of computing devices.

FIG. 10 is a flow diagram of an example process for generating executable code on a computing device according to the disclosure. The process illustrated in FIG. 10 can be implemented by the compiler 230 of the source device 105. While the discussion of the various stages refers to compiler 230, the compiler 710 illustrated in FIG. 7 can also be used to implement the process illustrated in FIG. 10. The process illustrated in FIG. 10 can be used to implement, at least in part, stage 905 of the process illustrated in FIG. 9.

One or more randomizable components in the source code can be identified for which the layout of the elements of the one or more randomizable component is to be randomized, the one or more randomizable components comprise one or more data structures, one or more objects, one or more data sections in the image file, or a combination of two or more of these (stage 1005). The source code can include one or more randomizable components including but not limited to data structures, objects, or other aggregate elements the layout of which can be randomized on the device on which the binary object code or intermediate code is to be deployed. The compiler 230 can be configured to recognize indicators or annotations that the programmer has included in the program code to identify data structures, objects, or other aggregate elements for which the layout can be randomized. A randomizable component can include one or more elements, members, or field (collectively referred to herein as “members”) that can be used to store data within the randomizable component. Each element may be a primitive data type, such as but not limited an integer, floating point number, character, or string, or may be another type of data structure or object, which in turn may include one or more elements. Additional types of randomizable components are discussed with respect to stage 1010.

Metadata can be generated that includes layout information for the one or more randomizable components for which the layout of the elements of the data is to be randomized (stage 1010). The compiler 230 of the source device 105 can be configured to provide the layout information to the metadata generation unit 270 which can generate the metadata for the image file. The metadata can include information about each of the randomizable components of the included in the program code that was compiled by the compiler 230. The image file generated by the compiler can also include other types of randomizable components, such as one or more data sections in the image file. The elements of the data section can include content, such as but not limited to read-only data segments (.rodata), statically allocated variables (.bss), constant variables (.const). The metadata can include information that identifies the one or more data sections in the image including the type of data stored in each data section. The device on which the image file is to be deployed can use the metadata to randomize the one or more data structures, one or more objects, one or more data sections in the image file, or a combination of two or more of these included in the image file. The source device 105 provides layout information for randomizable components that can be randomized on-device, rather than randomizing the randomizable components at the time that the image file is created. The on-device randomization can occur during application image installation, or application launching, or during device bootup, or during any idle time of the device and the application to which the image containing the randomizing components belong. However, in some implementations, the source device 105 may perform an initial randomization on the image file and the metadata provided to the client device 110 can reflect this randomized layout of the randomizable components of the randomized image file. The metadata generation unit 270 of the source device 105 can be configured to generate the metadata.

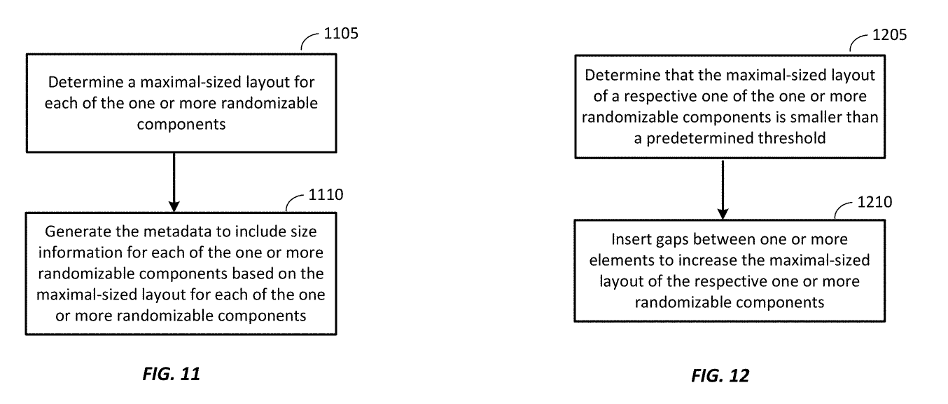

FIG. 11 is a flow diagram of an example process for generating executable code on a computing device according to the disclosure. The process illustrated in FIG. 11 can be implemented by the compiler 230 of the source device 105. While the discussion of the various stages refers to compiler 230, the compiler 710 illustrated in FIG. 7 can also be used to implement the process illustrated in FIG. 11. The process illustrated in FIG. 11 can be used to implement, at least in part, stages 1005 and 1010 of the process illustrated in FIG. 10.

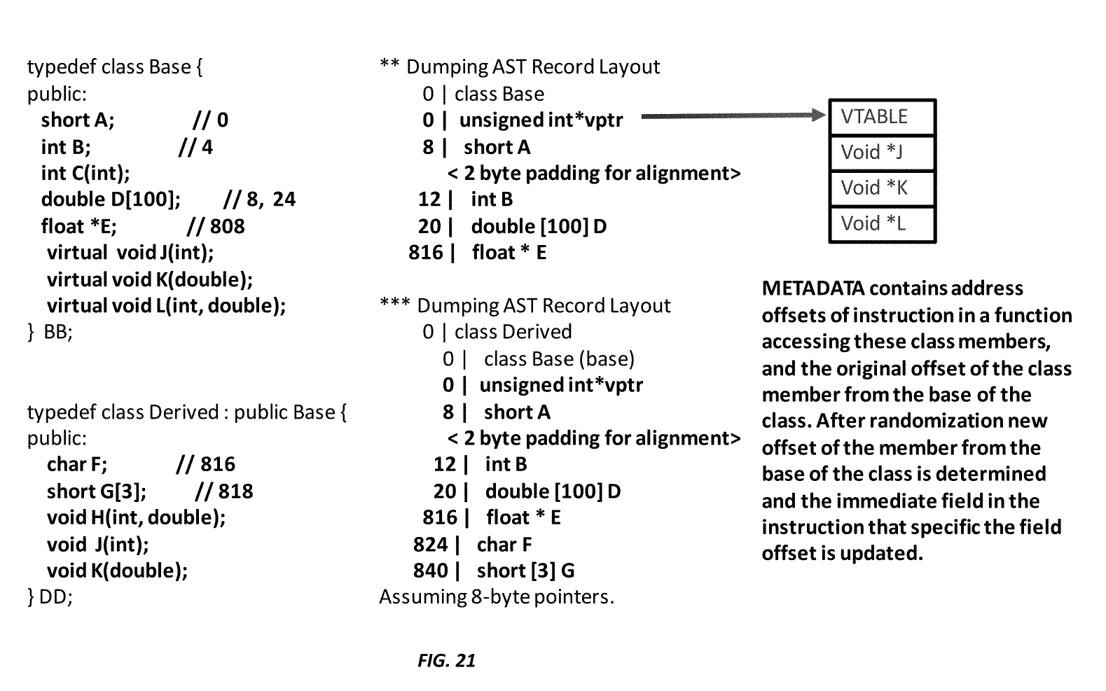

A maximal-sized layout can be determined for each of the one or more randomizable components (stage 1105). The maximal-sized layout incorporates all needed padding fields to maintain alignment constraints of the individual member types and to satisfy the programmer specific constraints as it tries all possible combinations of member field placement in the layout. The particular combination of member field layout, with the necessary padding field to satisfy alignment and programmer specific constraints, that leads to the largest size of the layout is the maximal sized layout. The compiler 230 can be configured to determine a maximal-sized layout for each of the one or more randomizable components that were identified in the program code. The compiler 230 can be configured to test multiple permutations of the layout of the randomizable component to determine a layout that has a maximal size for that randomizable component. The compiler 230 can select this as a layout of the randomizable component to be included in the image file. Alternatively, the compiler 230 can be configured to utilize a layout of the randomizable component included in the program code but can set the size of the randomizable component to the maximal size determined for that randomizable component. The compiler 230 can be configured to pad the randomizable component with additional unused memory space if necessary to ensure that the randomizable component is of the maximal size for that randomizable component. The compiler 230 can take into account constraints associated with the randomizable component when determining the maximal layout, such as but not limited to whether certain elements of the randomizable component are required to be aligned at particular byte boundaries (“alignment constraints”), padding constraints, and program-specified attributes and constraints associated with the respective one of the one or more randomizable components. The compiler 230 can also be configured to select instructions to include in the binary object code and/or intermediate code that include immediate operands that fit the maximal sized layout of the respective one of the one or more randomizable components with which the instruction is associated. For randomizable components in object-oriented implementations, the compiler 230 can be configured to determine the maximal sized layout of the object at each level of inheritance such that the layout of the elements of the object at each level of inheritance are independently randomized. An example of randomization of C++ class is provided in FIG. 21 to help illustrate these concepts. For C++, and other such object-oriented programming languages, the randomization can be done separately with the boundary of the same class members and for each virtual pointer table (Vtable) members pointers separately. In this example, the direct members (A, B, D, E) of the base class “Base” are randomized separately & independently of the direct members (F, G, and H) of the derived class “Derived”. The non-virtual function members of the respective class (e.g., C in Base class) can have its location reordered or start location randomized.

The randomization unit 370 can be configured to rewrite virtual function tables (also referred to herein as a “virtual method tables” or “virtual call tables”) associated with the classes that have been randomized. A randomized component may include a pointer to the virtual function table for that class. The virtual function table includes addresses to the dynamically bound methods associated with the randomized component. The virtual function table can be used to invoke the appropriate function at runtime. At compile time, it may not be possible to determine which function is to be called.

The compiler 230 can also be configured to select instructions to include in the binary object code that include immediate operands that fit the maximal sized layout of the object at each level of inheritance.

The metadata can be generated to include size information for each of the one or more randomizable components based on the maximal-sized layout for each of the one or more randomizable components (stage 1110). The metadata can include the size information for each of the randomizable components. The compiler 230 can be configured to provide the layout information to the metadata generation unit 270 of the source device to generate the metadata for the image file. The maximal-sized layout for each of the one or more randomizable components provide the randomization unit 370 of the client device 110 with the memory space needed to allow the randomization unit 370 to be flexible in determining a randomized layout of the elements of the randomizable component.

FIG. 12 is a flow diagram of an example process for generating executable code on a computing device according to the disclosure. The process illustrated in FIG. 12 can be implemented by the compiler 230 of the source device 105. While the discussion of the various stages refers to compiler 230, the compiler 710 illustrated in FIG. 7 can also be used to implement the process illustrated in FIG. 12. The process illustrated in FIG. 12 can be used to implement, at least in part, stage 1105 of the process illustrated in FIG. 11.

A determination can be made that the maximal-sized layout of a respective one of the one or more randomizable components is smaller than a predetermined threshold (stage 1205). The compiler 230 can be configured to determine whether a maximal-sized layout of a particular randomizable component is less than a threshold size. If minimum-sized threshold can be used to ensure that randomizable components are not too small, which can limit the number of permutations of the elements of the randomizable component that could be used by randomization unit of the client device 110.

Gaps can be inserted between one or more elements to increase the maximal-sized layout of the respective one or more randomizable components (stage 1210). The compiler 230 can be configured to insert gaps between one or more elements of the randomizable components to increase the size of the randomizable component. The additional space added by the gaps increases the amount of memory to be allocated to the randomizable component, and thus, the amount of space that the randomization unit 370 of the client device 110 has to work with when determining the randomized layout of the randomizable component. The compiler 230 can provide the information associated with the layout of the randomizable component, including any gap information, to the metadata generation unit 270 of the source device 105, which can use this information to generate the metadata for the image file.

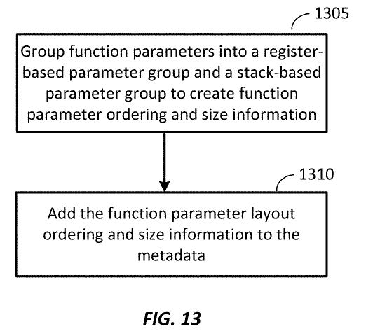

FIG. 13 is a flow diagram of an example process for generating executable code on a computing device according to the disclosure. The process illustrated in FIG. 13 can be implemented by the compiler 230 of the source device 105. While the discussion of the various stages refers to compiler 230, the compiler 710 illustrated in FIG. 7 can also be used to implement the process illustrated in FIG. 13. The process illustrated in FIG. 13 can be used to implement, at least in part, stage 1010 of the process illustrated in FIG. 10.

Function parameters can be grouped into a register-based parameter group and a stack-based parameter group to create function parameter ordering and size information (stage 1305). The compiler 230 can be configured to group the register-based parameters and the stack-based parameters into groups to facilitate randomization by the randomization unit 370 of the client device 110. The order of the register-based parameters can be permuted by the randomization unit 370 and the order of the stack-based parameters can be separately permuted by the randomization unit.

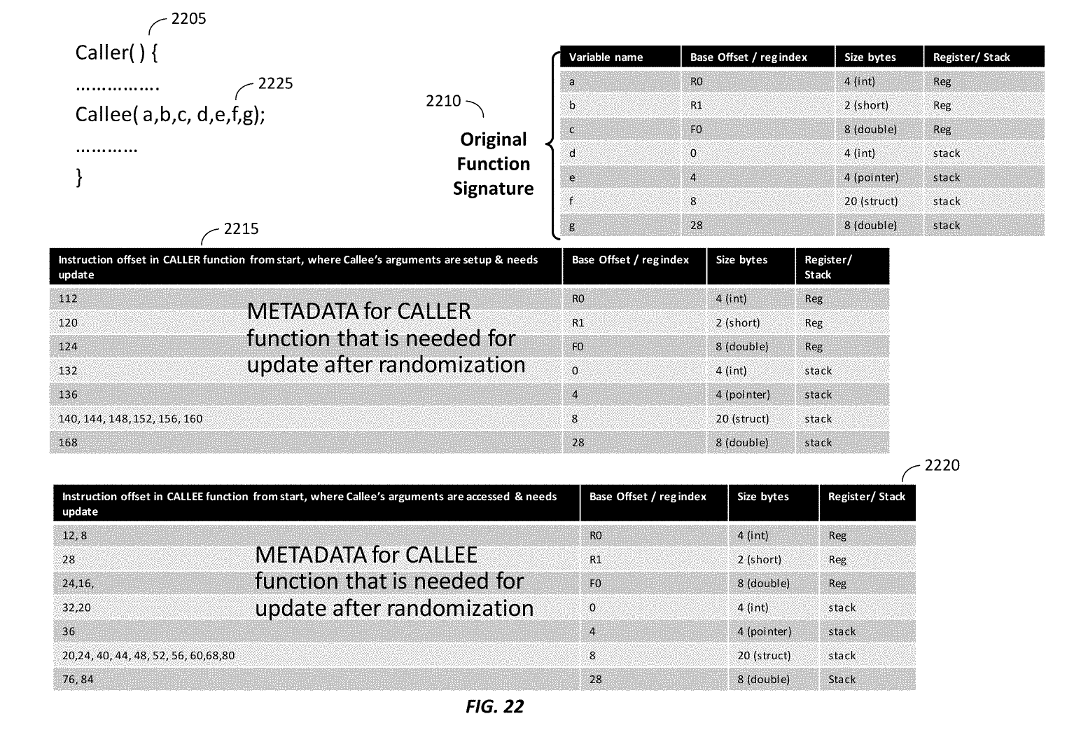

Referring now to FIG. 22, which illustrates an example of function parameter randomization. The example illustrated in FIG. 22 includes a caller function 2205, which is function that calls the callee function 2225. The callee function 2225 has seven parameters: a, b, c, d, e, f, g. Parameters a, b, and c are register-based parameters, and parameters d, e, f, and g are stack-based parameters. The original function signature information 2210 provides an example of the function signature that can be included in the metadata. The function signature information 2210 can include a variable name, a base offset or register index for the variable, a size of the variable (in bytes in this example), and an indicator whether the variable is a register-based variable or a stack-based variable. Caller information 2215 includes instruction offsets in the caller function 2205 associated with each of the variables and includes a variable name, a base offset or register index for the variable, a size of the variable (in bytes in this example), and an indicator whether the variable is a register-based variable or a stack-based variable. Callee information 2220 include instruction offsets in the callee function 2225 associated with each of the variables and includes a variable name, a base offset or register index for the variable, a size of the variable (in bytes in this example), and an indicator whether the variable is a register-based variable or a stack-based variable. The information included in FIG. 22 can be included in the metadata by the compiler 230 and/or the metadata generation unit 270. The randomization unit 370 of the client device 110 can use this information when randomizing the function parameter ordering. As discussed above, the register-based and the stack-based registers can be grouped together and randomized within their respective groups. The offset information included in the metadata can be used to update the caller and callee functions that are affected by the randomization.

The function parameter layout ordering and size information can be added to the metadata (stage 1310). The metadata generation unit 270 can receive the order of the function parameters and the size of each of the function parameters from the compiler 230 and can include this information in the metadata that is generated for the image file.

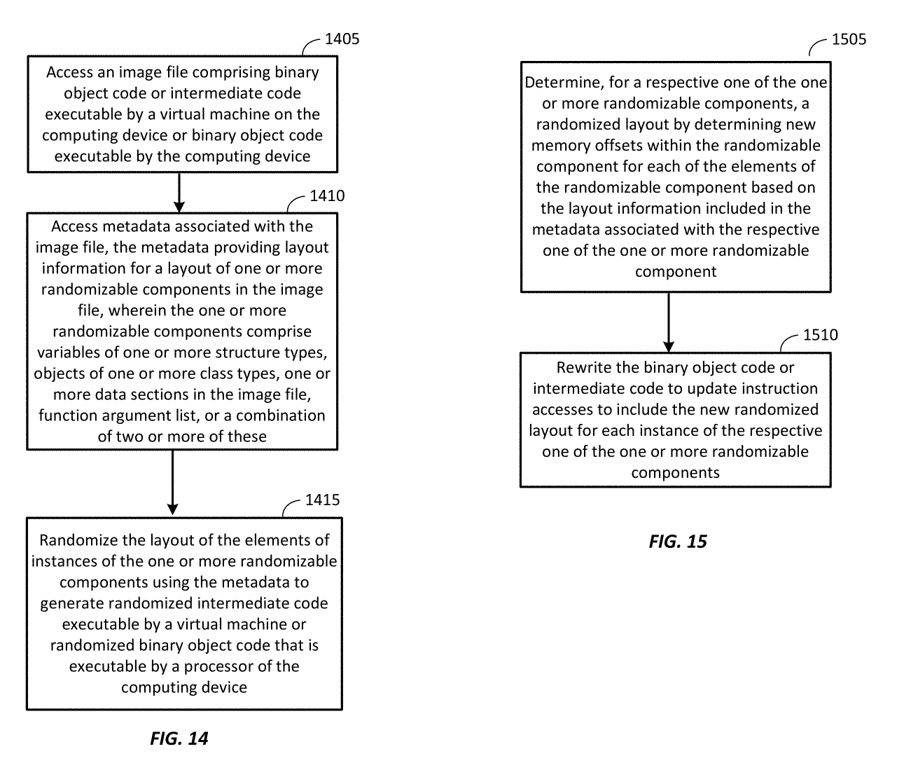

FIG. 14 is a flow diagram of an example process securing executable code on a computing device according to the disclosure. The process illustrated in FIG. 9 can be implemented by the randomization unit 370 of the client device 110. While the discussion of the various stages refers to randomization unit 370, the randomization unit 810 illustrated in FIG. 8 can also be used to implement the process illustrated in FIG. 14.

An image file comprising binary object code or intermediate code executable by a virtual machine on the computing device or binary object code executable by the computing device can be accessed (stage 1405). The randomization unit 370 of the client device 110 can be configured to access an image file that comprises binary object code or intermediate code. The image file can be obtained from the source device 105 or the content provider 120 depending upon the implementation. The image file can be stored in the memory 315 of the client device 110 as randomizable content 330.

Metadata associated with image file can be accessed (stage 1410). The metadata can provide layout information for a layout of one or more randomizable components in the image file. The metadata can provide layout information for a layout of one or more randomizable components in the image file. The one or more randomizable components can include variables of one or more structure types, objects of one or more class types, one or more data sections in the image file, function argument list, or a combination of two or more of these. The metadata can be generated by the source device 105, as discussed in the preceding example implementations, and can be provided with the image file. In some implementations, the metadata can be inserted into the image file, while in other implementations the metadata is provided with the image file as a separate file or files. The metadata can be stored in the can be stored in the memory 315 of the client device 110 as randomizable content 330 with the image file to be randomized.

The layout of the elements of instances of the one or more randomizable components can be randomized using the metadata to generate randomized intermediate code executable by the virtual machine or randomized binary object code that is executable by a processor of the computing device (stage 1415). The randomization unit 370 of the client device 110 can be configured to randomize the layout of the elements of the randomizable components of the computing device according to the various techniques disclosed herein. The metadata provides the randomization unit 370 with information about one or more data structures, one or more objects, one or more data sections in the image file, or a combination of. The randomization unit 370 can use this layout information to randomize the layout of elements of the one or more data structures and/or one or more objects included in the object code or intermediate code. The randomization unit 370 can also be configured to select instructions to be included in the binary object code that include immediate operands that fit the maximal sized layout of the structure or object being randomized. The maximal sized layout for each of the one or more randomizable components is determined based on the alignment constraints, padding constraints, and program-specified attributes and constraints for the respective one of the one or more randomizable components and the elements of the respective one of the one or more randomizable components. The layout of the metadata can include position or offset information, size information, and a data type information for each element of the respective one of the one or more randomizable components. The metadata can also include address offset information of each instruction included in the intermediate code or the binary object code that accesses or sets a size of one of the one or more randomizable components and/or base register offset information associated with each element of a randomizable component being accessed or set by an instruction of the intermediate code or binary object code.

The randomization unit 370 can also be configured to randomize the elements of an object at each level of inheritance separately to further increase the entropy of the randomization process. The randomization unit 370 can also randomize the order of parameters of function calls included in the object code and/or intermediate code as discussed in the preceding examples. For example, the randomization unit 370 can be configured to group function parameters in a register-based parameter group and a stack-based parameter group. Furthermore, the randomization unit 370 can be configured to rewrite debug symbol offsets and sizes of debugging information associated with the randomized binary object code and/or intermediate code according to the randomized layout of the elements of instances of the one or more randomizable components. Rewriting the debug information to operate with the randomized binary object code and/or intermediate code facilitates debugging of the randomized code that would otherwise have been broken due to the randomization of the layouts of the one or more randomizable components.

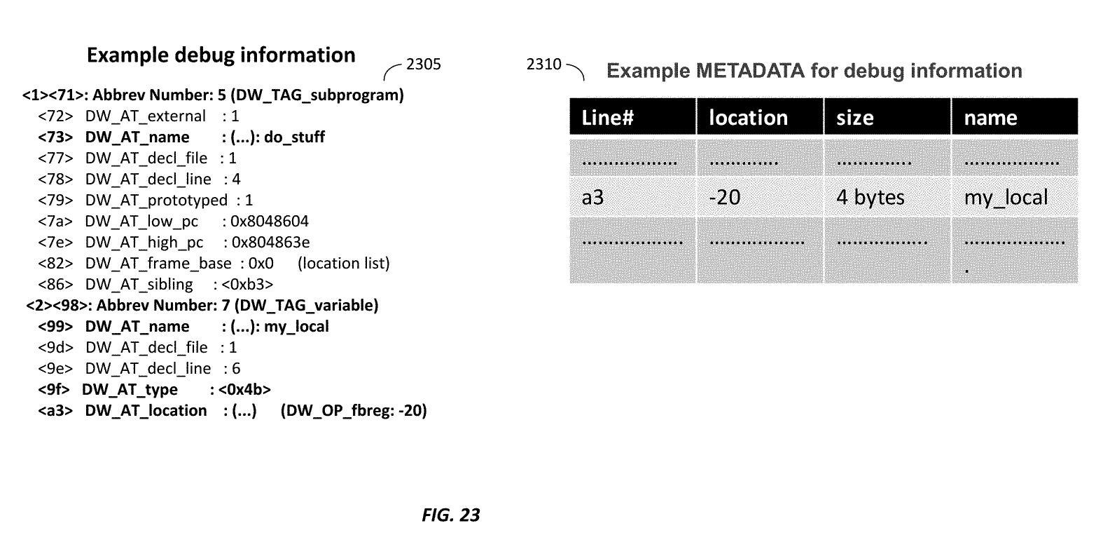

FIG. 23 provides an example of debugging information 2305 and an example of metadata 2310 that can be generated for such debug information. The debugging information 2305 can be in various formats depending upon the particular implementation, such as but not limited to the DWARF debugging data format. FIG. 23 illustrates the need to link program variables in the debugging information 2305 with their update locations due the layout randomization. The original debug information associated with an image file includes offset information that is based on the original location in the binary object code or intermediate code prior to layout randomization. The metadata 2310 points to the location of the offset for the data variable in the debug information. In this example, a debugger of the client device 110 can find my_local in do_stuff of the debugging information 2305. In the example debugging information 2305, the first number inside the angle brackets is the nesting level—my_local (DW_TAG_variable tag) with nesting level <2> is children of do_stuff function with <1>. The debugger is also interested in a variable's type to be able to display the variable correctly. In the case of my_local the type points to another DIE—<0x4b>. In this example, by looking up the variable type in the output of obj dump it can be determined that the variable is a signed 4-byte integer. To actually locate the variable in the memory image of the executing process, the debugger will look at the DW_AT_location attribute. For my_local it says DW_OP_fbreg: −20. This means that the variable is stored at offset −20 from the DW_AT_frame_base attribute of its containing function—which is the base of the frame for the function.

FIG. 15 is a flow diagram of an example process securing executable code on a computing device according to the disclosure. The process illustrated in FIG. 15 can be implemented by the randomization unit 370 of the client device 110. While the discussion of the various stages refers to randomization unit 370, the randomization unit 810 illustrated in FIG. 8 can also be used to implement the process illustrated in FIG. 15. The process illustrated in FIG. 15 can be used to implement, at least in part, stages 1410 and 1415 of the process illustrated in FIG. 14.

A randomized layout can be determined, for a respective one of the one or more randomizable components, by determining new memory offsets within the randomizable component for each of the elements of the randomizable component based on the layout information included in the metadata associated with the respective one of the one or more randomizable component (stage 1505). The randomization unit 370 of the client device can be configured to determine new memory offsets for each of the members of the randomizable component. The randomization unit 370 can be configured to randomly select the new locations of the elements of the randomizable component. However, the randomization unit 370 can be limited in the locations at which a particular element of the randomizable component may be placed based on constraint information included in the metadata. The metadata can include information constraint information that can restrict the placement of elements of the randomizable component. For example, the metadata can include one or more of alignment constraints, padding constraints, and program-specified attributes and constraints associated with the respective one of the one or more randomizable components that can limit where a particular element or elements may be placed within the randomized layout of the randomizable component. The randomization unit 370 can be configured to add padding to the randomized layout of the randomizable component to ensure that elements that are associated with alignment constraints satisfy those constraints after the layout of the randomizable component is randomized. The randomization unit 370 can be configured to spread the elements of the randomizable component throughout memory allocated to the randomizable component to increase entropy associated with the randomized layout of the randomizable components. The randomization unit 370 can also be configured to determine a separate randomized layout for each level of inheritance and to update the layout of virtual function tables associated with the a respective one of the one or more randomizable components where the respective one of the randomizable components is an object which inherits attributes from one or more other objects.

The binary object code and/or intermediate code can be rewritten to update instruction accesses to include the new randomized layout for each instance of the respective one of the one or more randomizable components (stage 1510). The randomization unit 370 can be configured to rewrite the binary object code and/or the intermediate code to reflect the randomized layout of the randomizable component(s) included therein. The randomization unit 370 can be configured to store the randomized binary image in the memory 315 as randomized content 335. The randomized image file can be executed by the client device 110 or may be installed on the client device 110 for later execution.

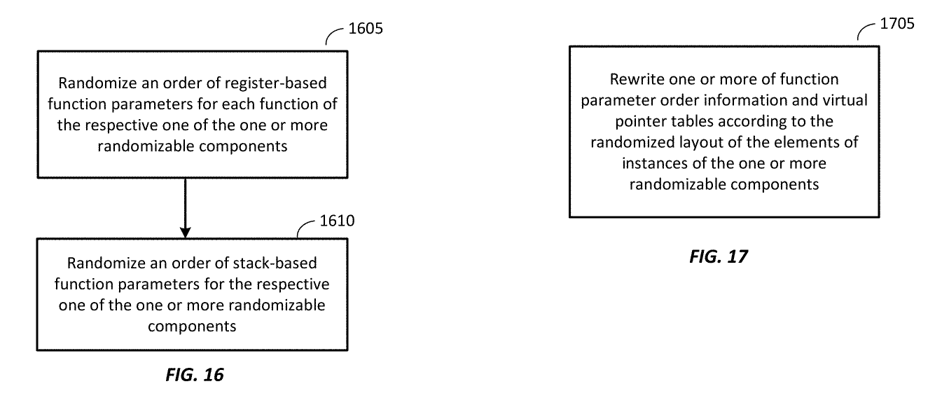

FIG. 16 is a flow diagram of an example process securing executable code on a computing device according to the disclosure. The process illustrated in FIG. 16 can be implemented by the randomization unit 370 of the client device 110. While the discussion of the various stages refers to randomization unit 370, the randomization unit 810 illustrated in FIG. 8 can also be used to implement the process illustrated in FIG. 16. The process illustrated in FIG. 16 can be used to implement, at least in part, stages 1415 of the process illustrated in FIG. 14.

An order of register-based function parameters can be randomized for each function of the respective one of the one or more randomizable components (stage 1605). One aspect of the randomization process that the randomization unit 370 can perform on the binary object code and/or intermediate code included in an image file is to randomize the order of function parameters for function calls included in the binary object code or intermediate code. The compiler 230 of the source device 105 can identify the register-based and the stack-based parameters in the metadata, and the randomization unit 370 of the client device can use this information to randomize the order of the register-based function parameters for each function call of a randomizable component.

An order of stack-based function parameters can be randomized for the respective one of the one or more randomizable components (stage 1610). The randomization unit 370 of the client device can use this information to randomize the order of the register-based function parameters for each function call of a randomizable component. The randomization unit 370 can be configured to rewrite the binary object code and/or the intermediate code based on the randomized order of these parameters to generate a randomized image file. The randomization of the function parameters can be performed in addition to or instead of the randomization of elements of the randomizable components as discussed above.

FIG. 17 is a flow diagram of an example process securing executable code on a computing device according to the disclosure. The process illustrated in FIG. 17 can be implemented by the randomization unit 370 of the client device 110. While the discussion of the various stages refers to randomization unit 370, the randomization unit 810 illustrated in FIG. 8 can also be used to implement the process illustrated in FIG. 17. The process illustrated in FIG. 17 can be used to implement, at least in part, stages 1415 of the process illustrated in FIG. 14.

One or more of function parameter order information and virtual function tables can be rewritten according to the randomized layout of the elements of instances of the one or more randomizable components (stage 1705). The randomization unit 370 can be configured to rewrite the order of function parameters of one or more functions or methods associated with randomizable components. As discussed in the preceding examples, the register-based and the stack-based parameters can be grouped together, and the randomization unit 370 can determine a randomized order for each of these groups of parameters.

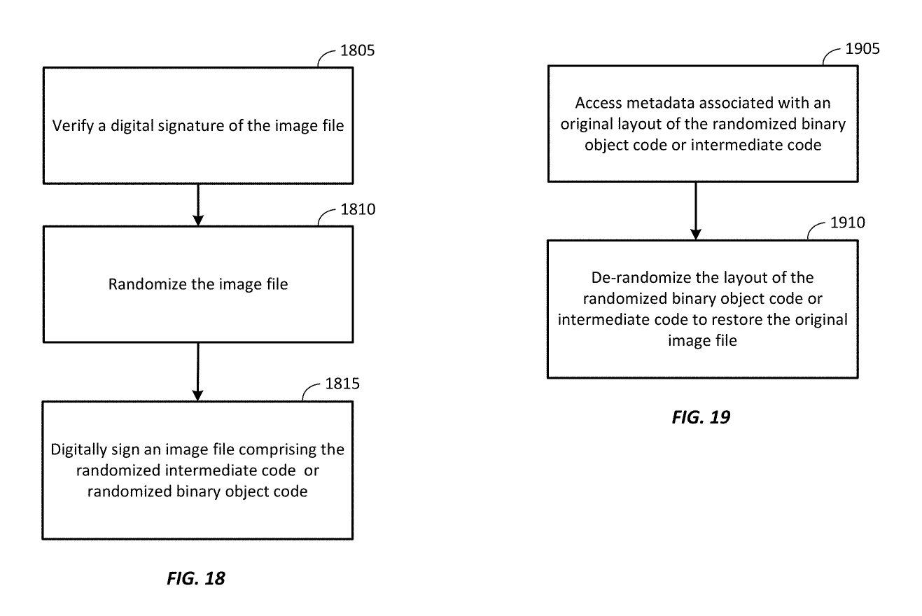

FIG. 18 is a flow diagram of an example process securing executable code on a computing device according to the disclosure. The process illustrated in FIG. 18 can be implemented by the randomization unit 370 of the client device 110. While the discussion of the various stages refers to randomization unit 370, the randomization unit 810 illustrated in FIG. 8 can also be used to implement the process illustrated in FIG. 18. The process illustrated in FIG. 18 can be used to implement, at least in part, additional stages of the process illustrated in FIG. 14.

A digital signature of the image file can be verified (stage 1805). The digital signature unit 375 of the client device 110 can be configured to verify the digital signature of the image file access in stage 1405 of the process illustrated in FIG. 14. The image file can be digitally signed by the source device 105 using a private cryptographic key associated with the source device 105 or by the content server 120 using a private cryptographic key associated with the content server 120. The source device 105 or the content server 120 can generate a hash of at least a portion of the image file and encrypt the hash value using the private cryptographic key associated with the device signing the image file to generate the digital signature. The digital signature unit 275 of the client device 110 can be configured to compute the hash value of the same at least a portion of the image file, to decrypt the encrypted hash value using the public cryptographic key associated with the signing device, and to compare the hash value computed by the digital signature unit 275 with the decrypted hash value. The digital signature unit 275 can be configured to throw a validation exception to halt processing of image file by the client device 110 responsive to the two hash values not matching. In some implementations, the image file may not be digitally signed, and stage 1905 can be omitted. Alternatively, device specific symmetric keys can also be used to encrypt and decrypt the new randomized binary. Device specific symmetric keys could also be used to provide authenticated encryption of the randomized binary, which combines symmetric encryption and checked integrity (using Message Authentication Code, i.e., MAC). These modes ensure both confidentiality and integrity.

The image file can be randomized according to the various techniques disclosed herein responsive to the signature on the image file being validated (stage 1815). The various randomization techniques discussed in the preceding examples can be executed by the randomization unit 370 to randomize the image file.

The image file comprising the randomized binary object code or randomized intermediate code can be digitally signed (stage 1815). The digital signature unit 375 of the client device 110 can be configured to digitally sign the randomized intermediate code or the randomized binary object code generated by the randomization unit 370 in stage 1415 of the process illustrated in FIG. 14. The digital signature unit 375 can be configured to sign the randomized intermediate code or the randomized binary object code by default or can be configured to sign the randomized intermediate code or randomized binary object code responsive to the original image file in which the intermediate code or binary object code having been signed. The original image file may have been signed by the source device 105 and/or the content provider 120. However, the client device 110 can sign the randomized intermediate code or the randomized binary object code with a device-specific cryptographic key that is maintained in a secure processing environment, such as the TEE 380 of the client device 110. The client device 110 can trust that the randomized intermediate code or the randomized binary object code that has been signed on the device by the digital signature unit 375 because the security of the cryptographic key is maintained on the client device 110.

FIG. 19 is a flow diagram of an example process securing executable code on a computing device according to the disclosure. The process illustrated in FIG. 19 can be implemented by the randomization unit 370 of the client device 110. While the discussion of the various stages refers to randomization unit 370, the randomization unit 810 illustrated in FIG. 8 can also be used to implement the process illustrated in FIG. 19. The process illustrated in FIG. 19 can be used to implement, at least in part, additional stages of the process illustrated in FIG. 14 or may be a standalone process for restoring the original layout of a randomized image file. The process illustrated in FIG. 19 can be used to restore the original layout of an image file that has been randomized. The original layout of the image file may be required to obtain an update for one or more software components of the client device 110. For example, the client device 110 may comprise a software update unit configured to periodically check for software updates for software installed on the computing device 110. An image file comprising software that is installed on the client device 110 may have been randomized at some point after the image file was received by the client device 110. However, in order to check for or obtain an update to the software, the image file may be required to be returned to the original layout in which the image file was received. The software update unit can be configured to check for and receive updates over the network 115 from the source device 105 and/or the content server 120. The randomization unit 375 can be configured to randomize the image file once the updates have been downloaded and/or installed.

Metadata associated with an original layout of the randomized binary code or intermediate code of a randomized image file can be accessed (stage 1905). The randomization unit 370 of the client device 110 can be configured to access the metadata associated with the randomized image file in which the binary code or intermediate code and/or other components of the image file were randomized. The randomization unit 370 can be configured to access the metadata from the memory 315 of the client device 110 in response to a request from the software update unit and/or other component of the client device 110. The metadata can be stored with the randomized content 335 in the memory 315 of the client device 110.

The layout of the randomized binary object code or intermediate code can be de-randomized to restore an original layout of the image file (stage 1910). The randomization unit 370 can be configured to restore the original layout of each of the randomizable components of the image file to an original state based on the metadata associated with the randomized components of the image file, including but not limited to data sections of the image file and binary object code and/or intermediate code that was randomized. The randomization unit 370 can also update the debug symbol offsets associated with the binary object code and/or intermediate code back to their original values so that debugging is possible should the restored image file be executed by the client device 110. The randomization unit 370 restores the original layout of each of the randomizable components, including restoring the original layout at each level of inheritance and the virtual pointer tables for objects that were randomized. The randomization unit 370 can be configured to store the restored image file as randomizable content 330 in the memory 315 of the client device 110. The restored image file may be re-randomized by the randomization unit 370 once the update or other process is completed.

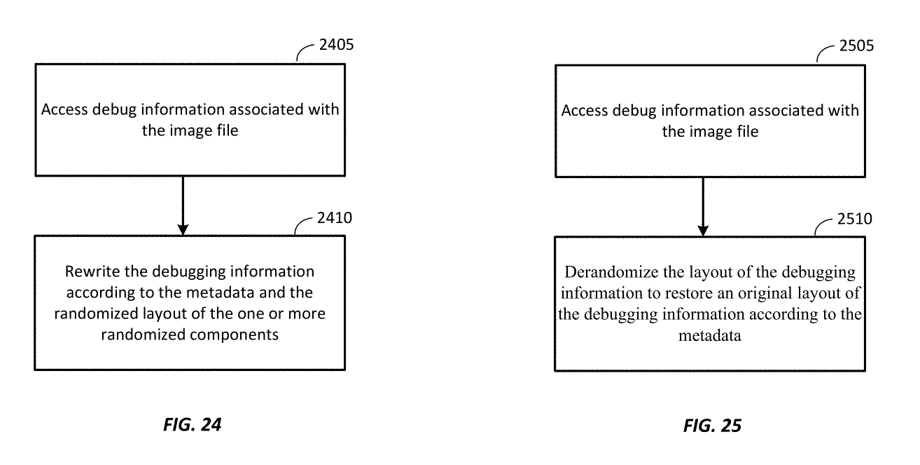

FIG. 24 is a flow diagram of an example process securing executable code on a computing device according to the disclosure. The process illustrated in FIG. 24 can be implemented by the randomization unit 370 of the client device 110. While the discussion of the various stages refers to randomization unit 370, the randomization unit 810 illustrated in FIG. 8 can also be used to implement the process illustrated in FIG. 24. The process illustrated in FIG. 19 can be used to implement, at least in part, additional stages of the process illustrated in FIG. 15 or may be a standalone process for restoring the original layout of a randomized image file. The process illustrated in FIG. 24 can be used to randomize the debugging information associated with an image file that has been randomized. The debugging information needs to be updated in response to the layout changes that were made to one or more randomizable components of the binary object code and/or intermediate code.

Metadata associated with randomized binary code or randomized intermediate code of a randomized image file can be accessed (stage 2405). The randomization unit 370 of the client device 110 can be configured to access the metadata associated with the randomized image file in which the binary code or intermediate code and/or other components of the image file were randomized. The randomization unit 370 can be configured to access the metadata from the memory 315 of the client device 110 in response to a request from the software update unit and/or other component of the client device 110. The metadata can be stored with the randomized content 335 in the memory 315 of the client device 110.

The layout of the debugging information associated with the binary object code and/or intermediate code can be randomized based on the randomized layout of the one or more randomizable components (stage 2410). The randomization unit 370 can be configured to write the offsets in the debugging information to account for the changes in the layouts of the randomizable components included in randomized image file. FIG. 23, which was discussed in detail above, illustrates an example of randomization of debugging information.

FIG. 25 is a flow diagram of an example process securing executable code on a computing device according to the disclosure. The process illustrated in FIG. 25 can be implemented by the randomization unit 370 of the client device 110. While the discussion of the various stages refers to randomization unit 370, the randomization unit 810 illustrated in FIG. 8 can also be used to implement the process illustrated in FIG. 25. The process illustrated in FIG. 25 can be used to implement, at least in part, additional stages of the process illustrated in FIG. 19 or may be a standalone process for restoring the original layout of randomized debugging information. The process illustrated in FIG. 25 can be used to restore the original layout of debugging information associated with an image file that has been randomized.

Metadata associated with an original layout of the randomized debugging information of a randomized image file can be accessed (stage 1905). The randomization unit 370 of the client device 110 can be configured to access the metadata associated with the randomized image file in which the binary code or intermediate code and/or other components of the image file were randomized for which the debugging information was also randomized. The randomization unit 370 can be configured to access the metadata from the memory 315 of the client device 110 in response to a request from the software update unit and/or other component of the client device 110. The metadata can be stored with the randomized content 335 in the memory 315 of the client device 110. FIG. 23 illustrates an example of randomization of debugging information.

The layout of the randomized debugging information can be de-randomized to restore an original layout of the debugging information (stage 2510). The randomization unit 370 can be configured to restore the original layout of each of the debugging information based on the metadata associated with the randomized components of the image file. The randomization unit 370 can be configured to store the debugging information with the derandomized image file as randomizable content 330 in the memory 315 of the client device 110. The restored image file and the debugging information associated therewith may be re-randomized by the randomization unit 370 once the update or other process is completed. The debugging information can be stored in various formats, including but not limited to the DWARF debugging data format.

Some example implementations according to the disclosure include an example method for generating executable code on a computing device.
1. An example method for generating executable code on a computing device, the method comprising:

compiling source code to generate binary object code or intermediate code, wherein compiling the source code comprises:
identifying one or more randomizable components in the source code for which the layout of the elements of the one or more randomizable component is to be randomized, wherein the one or more randomizable components comprise one or more data structures, one or more objects, one or more data sections in the image file, or a combination of two or more of these; and
generating metadata that includes layout information for the one or more randomizable components for which the layout of the elements of the data is to be randomized; and

generating an image file that includes the binary object code or the intermediate code and the metadata; and

providing the image file to one or more computing devices for execution by the one or more computing devices.
2. The method of example 1, wherein compiling the source code to generate the binary object code or the intermediate code further comprises:

determining a maximal-sized layout for each of the one or more randomizable components; and wherein generating the metadata that includes the layout information further comprises:

including size information for each of the one or more randomizable components based on the maximal-sized layout for each of the one or more randomizable components.
3. The method of example 2, wherein determining the maximal-sized layout for each of the one or more randomizable components further comprises:

determining that the maximal-sized layout of a respective one of the one or more randomizable components is smaller than a predetermined threshold; and

inserting gaps between one or more elements to increase the maximal-sized layout of the respective one or more randomizable components.
4. The method of example 2, wherein the one or more randomizable comprise an object, and wherein determining the maximal-sized layout for each of the one or more randomizable components further comprises:

determining that the maximal sized layout of the object at each level of inheritance such that the layout of the elements of the object at each level of inheritance are independently randomized.
5. The method of example 2, wherein determining the maximal sized layout for each of the one or more randomizable components further comprises:

determining that the maximal sized layout of a respective one or more randomizable components based on one or more of alignment constraints, padding constraints, and program-specified attributes and constraints associated with the respective one of the one or more randomizable components.
6. The method of example 2, wherein compiling source code to generate binary object code further comprises:

selecting instructions to include in the binary object code that include immediate operands that fit the maximal sized layout of the respective one of the one or more randomizable components with which the instruction is associated.
7. The method of example 6, wherein the one or more randomizable component comprises an object from an object-oriented program source, and wherein compiling source code to generate the binary object code or the intermediate code further comprises:

selecting instructions to include in the binary object code that include immediate operands that fit the maximal sized layout of the object at each level of inheritance.
8. The method of example 1, wherein generating the metadata that includes layout information for the one or more randomizable components for which the layout of the elements of the data is to be randomized further comprises:

grouping function parameters into a register-based parameter group and a stack-based parameter group; and

adding the function parameter layout ordering and size information to the metadata.
9. The method of example 1, wherein identifying one or more randomizable components in the source code for which the layout of the elements of the one or more randomizable components is to be randomized further comprises:

identifying an indicator in the source code associated with the one or more randomizable components indicating that the one or more randomizable components comprise sensitive information.
10. The method of example 1, the metadata comprises:

position or offset information, size information, and data type information for each element of the one or more randomizable components, and the address or address offset within a function body of the instructions in the intermediate code or the binary object code that access instances of the one or more randomizable components.

If implemented in-part by hardware or firmware along with software, the functions can be stored as one or more instructions or code on a computer-readable medium. Examples include computer-readable media encoded with a data structure and computer-readable media encoded with a computer program. Computer-readable media includes physical computer storage media. A storage medium can be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±30% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±30% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and can be based on one or more items and/or conditions in addition to the stated item or condition.

What is claimed is:

1. A method for securing executable code on a computing device, the method comprising:
accessing an image file comprising intermediate code or binary object code;
accessing metadata associated with the image file, the metadata providing layout information for a layout of one or more randomizable components in the image file, wherein the one or more randomizable components comprise variables of one or more structure types, objects of one or more class types, one or more data sections in the image file, function argument list, or a combination of two or more of these; and
randomizing the layout of elements of instances of the one or more randomizable components using the metadata to generate randomized intermediate code executable by a virtual machine or randomized binary object code executable by the computing device.

2. The method of claim 1, wherein randomizing the layout of the elements of instances of the one or more randomizable components further comprises:
determining, for a respective one of the one or more randomizable components, a randomized layout by determining new memory offsets within the respective one of the one or more randomizable components for each element of the respective one of the one or more randomizable components based on the layout information included in the metadata associated with the respective one of the one or more randomizable components; and
rewriting the binary object code or the intermediate code to update instruction accesses to include the randomized layout for each instance of the respective one of the one or more randomizable components.

3. The method of claim 2, wherein determining, for the respective one of the one or more randomizable components, the randomized layout further comprises:
padding the randomized layout to satisfy one or more alignment requirements associated with the elements of the respective one of the one or more randomizable components.

4. The method of claim 2, wherein determining, for the respective one of the one or more randomizable components, the randomized layout further comprises:
spreading the elements of the respective one of the one or more randomizable components throughout memory allocated to the respective one of the one or more randomizable components to increase entropy associated with the randomized layout of the respective one of the one or more randomizable components.

5. The method of claim 2, wherein determining, for the respective one of the one or more randomizable components, the randomized layout further comprises:
randomizing an order of register-based function parameters for each function of the respective one of the one or more randomizable components; and
randomizing an order of stack-based function parameters for the respective one of the one or more randomizable components.

6. The method of claim 2, wherein determining, for the respective one of the one or more randomizable components, the randomized layout further comprises:
determining a separate randomized layout for each level of inheritance and for virtual function tables associated with the respective one of the one or more randomizable components.

7. The method of claim 1, wherein a maximum size for each of the one or more randomizable components is determined based on alignment constraints, padding constraints, and program-specified attributes and constraints for the respective one of the one or more randomizable components and the elements of the respective one of the one or more randomizable components.

8. The method of claim 1, wherein the layout information of the metadata comprises position or offset information, size information, and a data type information for each member of the respective one of the one or more randomizable components.

9. The method of claim 1, wherein the metadata further comprises:
address offset information of each instruction included in the intermediate code or the binary object code that accesses or sets a size of one of the one or more randomizable components; and
base register offset information associated with each element being accessed or set by each instruction.

10. The method of claim 2, further comprising:
rewriting debug symbol offsets and sizes of debugging information according to the randomized layout of the elements of instances of the one or more randomizable components.

11. The method of claim 10, further comprising:
reconverting the randomized intermediate code or the randomized binary object code to original intermediate code or binary code using the metadata to restore an original layout for the one or more randomizable components in the image file for the one or more randomizable components.

12. The method of claim 11, further comprising:
restoring at least one of a function argument ordering and debug symbol offsets associated with each of the one or more randomizable components to original values.

13. The method of claim 11, further comprising:
signing reconverted intermediate code or reconverted binary object code using a device-specific cryptographic key associated with the computing device after reconverting the randomized intermediate code or the randomized binary object code to the original intermediate code or binary code using the metadata to restore the original layout, when either integrity protection is needed, or the image file was signed, and integrity protected.

14. The method of claim 1, further comprising:
signing the randomized intermediate code or the randomized binary object code using a device-specific cryptographic key associated with the computing device when either integrity protection is needed, or the image file was signed, and integrity protected.

15. The method of claim 1, wherein randomizing the layout of the elements of instances of the one or more randomizable components using the metadata to generate the randomized intermediate code or the randomized binary object code is performed responsive to an application utilizing the intermediate code or the binary object code being executed on the computing device, the method further comprising:
loading the randomized intermediate code or the randomized binary object code into a memory of the computing device from which the randomized intermediate code or the randomized binary object code can be executed.

16. The method of claim 1, further comprising:
storing the intermediate code or the binary object code from the image file in an original form a persistent memory of the computing device.

17. The method of claim 16, further comprising:
replacing the intermediate code or the binary object code in the original form with the randomized intermediate code or the randomized binary object code.

18. The method of claim 16, further comprising:
signing the randomized intermediate code or the randomized binary object code using a device-specific cryptographic key.

19. The method of claim 16, further comprising:
storing the randomized intermediate code or the randomized binary object code in the persistent memory of the computing device with the intermediate code or the binary object code in the original form.

20. The method of claim 2, further comprising:
rewriting one or more of function parameter order information and virtual function tables according to the randomized layout of the elements of instances of the one or more randomizable components.

21. The method of claim 1, wherein the one or more randomizable components comprise an object, wherein randomizing the layout of the elements of instances of the one or more randomizable components further comprises:
rewriting one or more of address offset information, base register offset information, function parameter order information, a virtual function table, debug information such that the layout of the elements of the object at each level of inheritance are independently randomized.

22. A computing device comprising:
means for accessing an image file comprising intermediate code or binary object code;
means for accessing metadata associated with the image file, the metadata providing layout information for a layout of one or more randomizable components in the image file, wherein the one or more randomizable components comprise variables of one or more structure types, objects of one or more class types, one or more data sections in the image file, function argument list, or a combination of two or more of these; and
means for randomizing the layout of elements of instances of the one or more randomizable components using the metadata to generate randomized intermediate code executable by a virtual machine or randomized binary object code executable by the computing device.

23. The computing device of claim 22, wherein the means for randomizing the layout of the elements of instances of the one or more randomizable components further comprises:
means for determining, for a respective one of the one or more randomizable components, a randomized layout by determining new memory offsets within the respective one of the one or more randomizable components for each of the elements of the respective one of the one or more randomizable components based on the layout information included in the metadata associated with the respective one of the one or more randomizable components; and
means for rewriting the binary object code or the intermediate code to update instruction accesses to include the randomized layout for each instance of the respective one of the one or more randomizable components.

24. The computing device of claim 23, wherein the means for determining, for the respective one of the one or more randomizable components, the randomized layout further comprises:
means for padding the randomized layout to satisfy one or more alignment requirements associated with the elements of the respective one of the one or more randomizable components.

25. A computing device comprising:
a processor configured to
access an image file comprising intermediate code or binary object code;
access metadata associated with the image file, the metadata providing layout information for a layout of one or more randomizable components in the image file, wherein the one or more randomizable components comprise variables of one or more structure types, objects of one or more class types, one or more data sections in the image file, function argument list, or a combination of two or more of these; and
randomize the layout of elements of instances of the one or more randomizable components using the metadata to generate randomized intermediate code executable by a virtual machine or randomized binary object code executable by the computing device.

26. The computing device of claim 25, wherein the processor being configured to randomize the layout of the elements of instances of the one or more randomizable components is further configured to:
determine, for a respective one of the one or more randomizable components, a randomized layout by determining new memory offsets within the respective one of the one or more randomizable components for each element of the respective one of the one or more randomizable components based on the layout information included in the metadata associated with the respective one of the one or more randomizable components; and
rewrite the binary object code or the intermediate code to update instruction accesses to include the randomized layout for each instance of the respective one of the one or more randomizable components.

27. The computing device of claim 26, wherein the processor being configured to determine the randomized layout is further configured to:
pad the randomized layout to satisfy one or more alignment requirements associated with the elements of the respective one of the one or more randomizable components.

28. A non-transitory, computer-readable medium, having stored thereon computer-readable instructions for securing program code on a computing device, comprising instructions configured to cause the computing device to:
access an image file comprising intermediate code or binary object code;
access metadata associated with the image file, the metadata providing layout information for a layout of one or more randomizable components in the image file, wherein the one or more randomizable components comprise variables of one or more structure types, objects of one or more class types, one or more data sections in the image file, function argument list, or a combination of two or more of these; and
randomize the layout of elements of instances of the one or more randomizable components using the metadata to generate randomized intermediate code executable by a virtual machine or randomized binary object code executable by the computing device.

29. The non-transitory, computer-readable medium of claim 28, wherein the instructions configured to cause the computing device to randomize the layout of the elements of instances of the one or more randomizable components further comprise instructions configured to cause the computing device to:
determine, for a respective one of the one or more randomizable components, a randomized layout by determining new memory offsets within the respective one of the one or more randomizable components for each element of the respective one of the one or more randomizable components based on the layout information included in the metadata associated with the respective one of the one or more randomizable components; and rewrite the binary object code or the intermediate code to update instruction accesses to include the randomized layout for each instance of the respective one of the one or more randomizable components.

30. The non-transitory, computer-readable medium of claim 29, wherein the instructions configured to cause the computing device to determine the randomized layout further comprise instructions configured to cause the computing device to:
pad the randomized layout to satisfy one or more alignment requirements associated with the elements of the respective one of the one or more randomizable components.
